(19) United States
(12) Patent Application Publication
(10) Pub. No.: US 2019/0316737 A1
(43) Pub. Date: Oct. 17, 2019

(54) Tracking Inspection Attributes In Piping Installations

(71) Applicant: MSP Resourcing Canada Inc., Regina (CA)

(72) Inventors: Scott Boker, Canal Flats (CA); Bryan Janz, Regina (CA)

(21) Appl. No.: 16/259,166

(22) Filed: Jan. 28, 2019

Related U.S. Application Data
(63) Continuation of application No. 15/111,037, filed on Jul. 12, 2016, now abandoned.

(30) Foreign Application Priority Data
Jan. 16, 2014 (CA) 2839467

(51) Int. Cl. F17D 5/00; F16L 1/06; H04L 12/16; H04L 29/08; G06F 16/22; F16L 55/00; G06F 16/245; F17D 3/00

(52) U.S. Cl. CPC F17D 5/00; F16L 1/06; H04L 12/16; F17D 3/00; G06F 16/22; F16L 55/00; G06F 16/245; H04L 67/1097

(57) ABSTRACT

Inspection attributes including non-destructive (NDE) examination information related to piping connections in a finished piping installation, are stored in an attribute database with relative location information. Inspection attributes can be entered and updated in the attribute database in the field using a client-server software application and mobile client devices. Components in the field will be serially marked, which will streamline field data entry. Direct field entry of attribute information in the attribute database represents a significant efficiency enhancement over prior methods. A complete chronological inspection history for component connections is created.

### CROSS-REFERENCE

This application is a continuation of U.S. patent application Ser. No. 15/111,037, filed on Jul. 12, 2016 (pending), which is a National Stage entry of International Patent Application No. PCT/CA2015/000025, filed Jan. 16, 2015, the disclosures of which are incorporated by reference herein.

### FIELD OF THE INVENTION

This invention is in the field of pipeline and piping installation construction, and more specifically deals with a mobile-enabled data management system for the storage and manipulation of inspection attributes of piping component connections and finished pipelines and piping installations.

### BACKGROUND

As industrial installations become more complex, the amount of information which is used in their construction and ongoing maintenance proliferates. Management and exploitation of this data is a difficult task and there are all manner of efforts made to streamline processes in the aggregation and use of this information.

Construction of pipelines and similar installations is one industrial construction application facing this difficulty. Pipelines are often constructed over literally thousands of miles, and the importance and complexity of construction of pipelines is rendered even more important by the significant environmental impact of these projects, both in their construction as well as if there is failure of any components and repair required. Typical pipeline construction comprises the assembly of lengths of steel pipe and other fitments such as valves and the like into a fluid or gas conduit between two points. To accommodate either the size and volume, or in many cases the pressure of the pipeline under load, the preferred method of attachment of the components into a pipeline is to weld the steel components together at their joints to yield the strongest possible completed unitary structure.

During construction of a pipeline it is necessary to monitor and track the physical inspection attributes of the materials used—ie. structural testing, pressure test values, etc. of particular specific pipes etc.—along with visual inspection and other non-destructive testing of the welds or other connections between components to ensure that the structural integrity of the finished pipeline will meet the specifications or requirements of the customer or the project. Collection of all of this information, from a safety and information management perspective, has in the past basically been collected by paper data capture and record keeping processes.

Part of the completion of an actual construction project such as this is to try to make some sense of all of the paper inspection records captured in the field and either organize them in a paper filing system or transpose the salient information therefrom into some type of information management system. The enormity of this task leads to it being done in a delayed fashion, and construction or operations personnel may be inclined to only track the bare minimum inspection attributes and testing information rather than a more fulsome set of information with respect to particular piping components and joints since the thinning out of the information maintained simplifies the tracking task. If there were an alternate method of capturing and tracking these types of information, which minimized the amount of data entry or duplicated, or record-keeping effort involved in maintaining that data store it is believed that this would be a desirable outcome.

From a regulatory or record-keeping perspective it is very important to be able to not only capture details of the inspection of the construction work in the building of the pipeline, or the results of ongoing maintenance or inspection, but also to tie the tracked information to a particular location on the pipeline. Particularly in a case where a pipeline once constructed may be buried underground, knowing the approximate geo-coordinates of the components in addition to the inspection results and other inspection attributes is also important, in case it is ever necessary to locate, inspect and/or replace certain components etc. In past approaches there have been many ways of capturing and identifying the location or coordinates of a particular component—for example a relative position along the pipeline from particular reference points, or a GPS snap—which is transposed into the paper generated or paper-based record-keeping system. Again, finding a way to tie component inspection attributes or other nondestructive examination information to geolocation coordinates with the minimum amount of data capture or data entry effort would be a desirable outcome.

It will be understood that there are many ongoing applications or extensions of the business tasks associated with the construction and operation of a pipeline which are driven off of this type of a record-keeping system and which could benefit from its modernization. For example, it is obviously required to inspect pipelines from time to time—in a traditional context, periodic inspection of the pipeline or piping installation would again result in the capture of large quantities of paper field reports, which again would need to be transcribed into whatever type of paper or electronic record-keeping system was implemented off of that paperwork. Development of an information system which could capture and maintain all of these types of information while minimizing the need for paper data capture would it is believed to be favorably received in the industry.

One of the other limitations of current paper-based record-keeping systems is also the limited ability to in a streamlined fashion execute a query against the paper-based record-keeping system to identify particular components or joints and their locations which might require for example inspection, maintenance, replacement for defect or recall etc. Development of an electronic data system which allowed for the streamlined tracking of a maximum number and type of inspection attributes including nondestructive examination information with respect to particular components and their joints within the pipeline, for provision of a query and reporting apparatus, would also be desirable from this perspective.

The proliferation of personal technology and computing devices could it is believed be applied in this area to provide some relief to these prior art limitations. For example, if it were possible to develop and implement a record-keeping system in accordance with the underlying business problem here that permitted the use of tablet computing devices or other mobile computing devices for data entry, directly through a client/server connection to an attribute database, inspection results, inspection attributes and other nondestructive examination information could be captured directly to the database from the field. A business information system that allowed for the direct entry of nondestructive examination or other inspection attributes or information in the field, as pipelines were constructed or inspected, would provide a significant commercial advantage. Most mobile computing devices now also include GPS or other location technology which would allow for reasonably simple capture of geo-coordinates if required within the overall architecture of such a system.

A system which allowed for the direct entry of field inspection attributes or field-captured piping data regarding piping components or component connections, rather than using paper field reports, would not only streamline the process but in doing so would also allow users of such a system to maintain a broader data set of inspection attributes and inspection information to allow for optimized and maximized maintenance of their pipeline assets which would have obvious commercial impact. The regulatory benefit of a streamlined data store such as this will also be obvious and would be desirable as regulatory environments become more and more complicated.

### SUMMARY OF THE INVENTION

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As outlined above, the present invention is a method of capturing and tracking the details of various inspection attributes related to the components and connections in a piping installation. Inspection attributes and other parameters of piping components in the piping installation as well as the connections therebetween can be stored in the database. The piping installation itself is comprised of a plurality of identified connected components. Each component has at least one identify connection thereon for connection to an adjacent component, and the components in the piping installation are connected to adjacent components in connections and adjacent connection points thereon.

Inspection attributes including the results of nondestructive testing of piping components or component connections as well as the results of in person personnel examination of piping components or component connections in the piping installation will be stored within an attribute database and will be captured in the field and entered to the database using varying types of mobile devices rather than needing to be transposed or entered at a central location for paper field reports. The ease of deployment and use of this system will contribute to its attraction to users within the pipeline construction, operation and maintenance industry. The system and method of the present invention will result in the creation of a complete historical inspection log for component connections or components, which can be used for reporting or query purposes.

Architecturally it is contemplated the system of the present invention will be delivered in a client/server environment. Many of the architectural requirements and understanding for the programming delivery of business systems such as this on web platforms or otherwise will be understood to those skilled in the art of client/server and web programming and all such implementations thereof are contemplated within the scope of the present invention. Software components and an attribute database resident on or operatively connected to a server of the invention will be used to facilitate the method and system of the present invention. An operator in the field through a viewing or data entry client on a mobile device could enter inspection attributes are testing information which were correlated with particular piping components by location or otherwise.

The method of the present invention comprises assembly of an attribute database which includes a plurality of connection records each identifying a component connection between at least two specified connection points up to adjacent components, and a plurality of inspection attribute records each linked to a component connection record, each inspection attribute record storing at least one inspection attribute of the related identified component. Basically, the invention comprises virtual data modelling of a pipe installation from one end to the other, by joining together a plurality of connected components by tracking each identified component connection. Both in terms of a general data picture as well as graphic modelling, this basic information outlining the identified piping components and the identified component connections therebetween allows for the creation of a model of the pipeline. Inspection attributes stored in inspection attributes records linked to the connection records are the component records in the database can then be visualized or reported alongside the other information related to the component connections in the pipeline or piping installation.

Following the creation of the connection records corresponding to the piping installation in the attribute database, inspection attribute records could be created in the attribute database. An inspection attribute record would contain the details of a particular attribute or inspection which was conducted of a component connection in the piping installation. Inspection attribute records and their details would be created by the capture and upload of inspection or assessment results from the field by operators at remote client devices to the attribute database on the central server. The field inspection client devices might be connected by network to the server and to the attribute database on a real-time basis or might from time to time be connected to synchronize therewith. In any event, client software installed upon the field inspection client devices, working in conjunction with the server in the software components thereon, will allow for the capture and entry of component or connection inspection attributes or other information in the field pertaining to particular components or component connections in a piping installation, which through their direct entry on a client device by a remote operator can be synchronized or transmitted to the server for storage to the attribute database in relation to their related component connections.

The attribute database itself could have many structures and store many types of information. This application outlines some options in terms of the types of data structures which could be developed—it is specifically contemplated that any type of data could comprise an inspection attribute captured for recordal to the system in relation to a component connection in the piping insulation—for example audio, video or photographs could even be captured—so long as the necessary adjustments were made to the record structure of the database. In certain circumstances the administration of the server and the system would also allow for an administrator to customize the types of inspection attributes to be tracked or captured in respect of particular types of piping installation components.

The remote data capture method of the present invention, for the automated transmission and synchronization of inspection attribute data to an attribute database in respect of the components and connections in a piping construction project, enables many different types of added value business methods to be undertaken with respect to piping construction. For example, reasonably contemporaneous capture of this inspection information or even capture of the data indicating completion of component connections in the piping construction process can be used as query triggers or query criteria to identify areas of the piping project which require follow-up inspection or other construction steps to take place.

The invention comprises a method of tracking inspection attributes in a piping installation comprised of a plurality of serially identified component connections. By assigning an identifier to the connection, the ability to link in the database each connection to each component and to facilitate the building of a data or visual model of the completed piping installation is facilitated. Components in the piping installation are connected to adjacent components in connections and adjacent connection points. It is then the desire of the method of the present invention to track inspection attributes related to various components of the piping installation or to the connections between the components.

The method first comprises providing a server which in turn comprises an attribute database containing a plurality of connection records, each of which identifies a component connection between two specified adjacent components in the completed piping installation. Finally, there are also included in the attribute database a plurality of inspection attribute records, each of which is linked to a component connection record, each inspection attribute record storing at least one inspection attribute related to the identified component connection to which it is linked. The server also has a network interface for communication with at least one field inspection client device, and server software for administering the attribute database and managing communications with the field inspection client devices.

In practice of the method and operator of a field inspection client device having an operator interface and which is operably connected to communicate with the server and having field inspection software installed thereon, will enter via the operator interface thereof the details at least one inspection attribute related to an identified component connection in the piping installation. This is an entered connection inspection attribute. The field inspection client device will transmit the entered connection inspection attribute along with the details of the related identified component connection itself to the server—this is a component connection inspection transmission or packet.

On receipt of a component connection inspection transmission at the server, the entered connection inspection attribute and details of the related identified component connection are used to create an inspection attribute record in the attribute database which stores the details of the entered inspection attributes in relation to the five connection multiple inspectors using multiple devices can transmit the results of multiple assessments and inspections for storage to the database and the server. Contemporaneous capture of the information in the field will yield the most accurate results as well as the most timely results without the need for any manual record-keeping.

Similar to the ability to capture and receive inspection attribute details with respect to particular connections of piping components in the piping installation, the method will also comprise an ability for an operator to make an inspection or observation in the field related to a particular component in a piping installation and to transmit that as an entered component inspection attribute to the server for the creation of an inspection attribute records related to that component.

The method could also include storage of acceptable inspection parameters in the database in relation to connection records therein, and exception reports or user notifications could then be generated when a particular inspection attribute record was created or stored to the database which indicated an inspection attribute outside of those acceptable inspection parameters. The system and method of the present invention will result in the creation of a complete historical inspection log for component connections or components, which can be used for reporting or query purposes.

As outlined elsewhere herein, the connection records in the database could each include a component connection location, of that connection within the completed piping installation. That could simply be a location in reference to other components or could be a geo-referenced location. By including geo-referenced locations in the records in the database, various added functionality can be contemplated where the field inspection client devices are locationally aware and can transmit their own geolocation to the server, for comparison or extraction of relevance or nearby components, connection or inspection attribute information from the database based on the location of the client device. The system and method of the present invention will result in the creation of a complete historical inspection log for component connections or components, which can be used for reporting or query purposes.

The types of inspection attributes which can be saved to the database both in terms of the nature of the data stored as well as the nature of the inspection is undertaken could include any type of data that was capable of being stored to a database of the necessary data structure modifications thereto, as well as being able to accommodate any number of different types of either in person personnel inspections, or other types of nondestructive examination should be conducted of component connections or components within the pipeline. In many cases, pipelines are comprised of welded metal pipe sections—the welds would comprise the connections and the pipe sections would comprise the components. This is only one example but is provided for demonstrative purposes. Alternatively, the connections themselves between adjacent piping components could for example comprise gaskets used to join adjacent flanges or the like.

The software on the client device can either be a web browser and the necessary software components could be used on server to allow for the transmission and receipt of information to and from a client device from the server. In other circumstances of purpose built client software might be used—both such approaches are contemplated herein.

In addition to the method of the present invention, the server and database combination disclosed is also a portion of the invention as well as the data structure and the database itself.

### DESCRIPTION OF THE DRAWINGS

Selected preferred embodiments of the present invention will now be described with reference to the accompanying drawings. In the accompanying drawings:

FIG. 1 shows a small sample of typical pipeline construction, for descriptive background purposes;

FIG. 2 is a block diagram showing the components of one example of a pipeline installation as shown in FIG. 1, with the addition of serialized component and connection markings in accordance with the present invention;

FIG. 3 is a diagram showing the key elements of the data structure of one embodiment of the attribute database of the present invention;

FIG. 4 is a flow chart showing the steps of one embodiment of the method of data capture regarding inspection or construction of a piping installation in accordance with the present invention;

FIG. 5 is a flow chart showing the steps of one embodiment of the field entry of attribute data to the database of the present invention;

FIG. 6 is a flow chart showing the steps of one embodiment of the field retrieval of attribute data to a client device from the attribute database in accordance with the present invention;

FIG. 7 shows an illustrative network environment of the system of the present invention;

FIG. 8 is a schematic diagram of an illustrative server of the present invention;

FIG. 9 is a schematic diagram of an illustrative client device of the present invention;

FIG. 10 is a block diagram demonstrating the various components of the tracking software of the present in one embodiment of the present invention

FIG. 11 is a flowchart showing the steps involved in one embodiment of the initial population of component records in the attribute database;

FIG. 12 is a flowchart showing the steps involved in one embodiment of the initial creation or population of a component connection record in the attribute database;

FIG. 13 is a flow chart showing the steps of one embodiment of a piping construction method in accordance with the present invention;

FIG. 14 is a flowchart showing the steps of one embodiments of a method of pipeline construction and inspection in accordance with the present invention; and

FIG. 15 is a flowchart showing the steps of one embodiment of the method of capture of a locationally referenced pipeline asset inventory in accordance with the present invention.

### DETAILED DESCRIPTION OF THE ILLUSTRATED EMBODIMENTS

The present invention is a method for enhanced data entry and aggregation with respect to the inspection attributes of piping components used in the construction of pipelines and other piping installations. Attributes and nondestructive testing data with respect to components and connections in a piping installation would be captured and locationally correlated in an attribute database. The following describes the various embodiments of the invention in further detail.

### Scope of the Invention—Piping Installations

One of the key things to appreciate with respect to the scope of the present invention is the scope and nature of the different types of piping installations in respect of which the method of the present invention can be used. Any fluid or gas conduit between two points is contemplated for the purposes of the present invention as a pipeline. In addition to varying lengths or complexities, pipelines can either be low or high pressure installations. The term “pipeline” is used in the context of the present invention to refer to any type of a piping installation of a local or long distance nature—the present invention could be just as useful in a dense local piping installation such as a refining or other industrial facility, as it could be in a long distance pipeline application, and all such types of piping installations, made up of piping components to yield a completed conduit are contemplated within the scope hereof. The invention disclosed herein will be useful for all types of pipelines in their construction and in terms of record-keeping on the elements of the construction of the pipeline as well as for ongoing maintenance and review purposes.

While the method of collection of inspection attributes related to piping components and connections of the present invention has obvious utility with respect to the assembly of a complete data set with respect to a long distance pipeline, it will also be understood that the type of piping installations in respect of which the method could be used also includes any other type of a piping or conduit installation, such as an industrial installation or the like. Shorter distance or more densely constructed industrial piping installations could have as much or more complexity in their construction as well as in the need for the maintenance of inspection information and the like and the method of the present invention would be just as useful in tracking information with respect to those types of installations.

Dependent on the degree of granularity which can be obtained from available GPS location technology, GPS may not be the desired method of capturing geo-tag or location reference information with respect to particular components or component connections in a more densely located industrial installation—where GPS would not be desirable, different types of location technology including the use of some kind of a site-specific or locationally installed radio technology or other types of approaches can also be used.

### Component Terminology

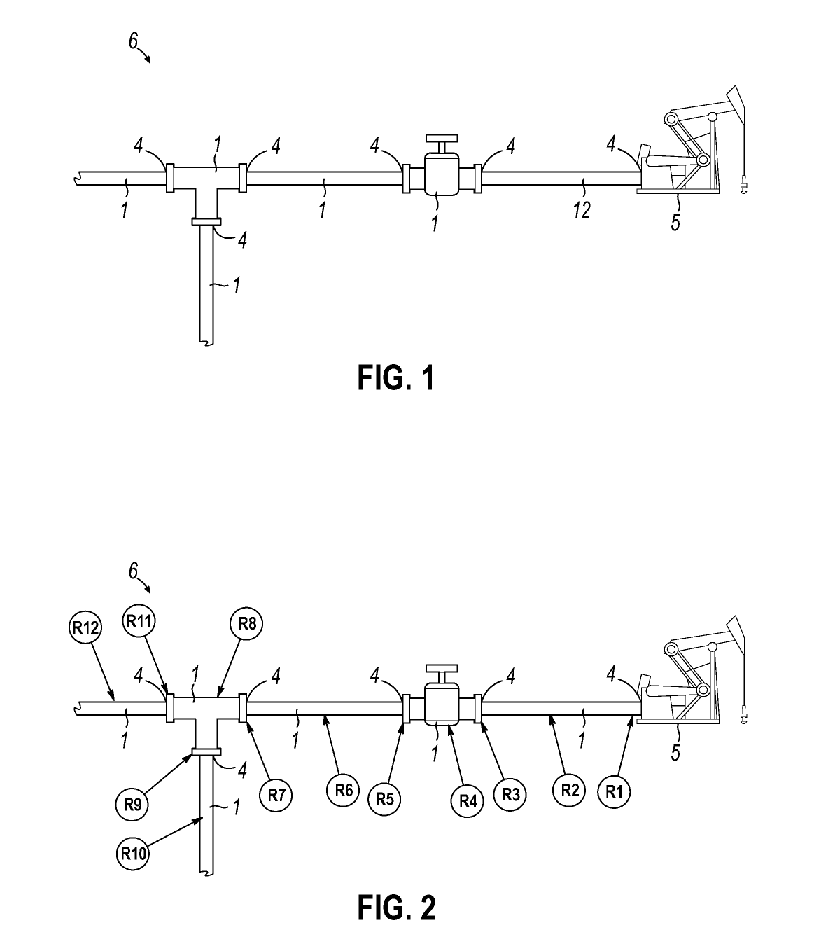

For the purpose of discussion of many of the general concepts around pipelines and pipeline construction we refer to FIG. 1, which is a diagram of a small portion of a completed pipeline. There is shown a portion of a pipeline 6 connected to an oil well 4. In this case a pipeline attached to an oil well is shown for demonstrative purposes, but it will be understood that any number of different types of piping installations are contemplated to be within the scope of the utility of the present invention. The completed pipeline 6 shown in FIG. 1 could be either a conduit for transport of oil from the oil well 5, or a pipe for the pumping and delivery of required inputs to the well 5.

Pipeline 6 is a completed conduit made up of a plurality of piping components 1—when the piping components 1 are completely connected together they define a material path through which the material which is desired to be transported [gas, fluid or otherwise] can be moved. There are many different types of conduit-defining components 1 which might be connected into a completed pipeline 6. There are shown four piping components 1 which are a section of pipe 2, one piping component 1 which is a valve, shown at 3, and one piping T junction shown at 7 for demonstrative purposes. Each of these components insofar as they would comprise a portion of the material path in a finished conduit are pipeline 6 is considered a piping component 1 within the scope of the disclosure herein. Valves, compressors, and any number of different types of in-line components could be placed into a piping installation, and all are contemplated within the scope of the present invention.

Generally speaking the construction of a pipeline consists of the selection of a path or a route for the pipeline, preparation of a bed onto or into which the pipeline can be installed, and the delivery of the necessary piping components along the path or route for connection or construction into the finished pipeline or piping installation. For example, lengths of pipe will be deposited along the length of the pipeline route or right of way, and the construction crew can then work their way along the route and weld together the sections of piping, or other valves or components, into completed pipe strings. Once the sections of pipe are welded together or otherwise connected, the joints between the pipes or other components can be tested nondestructively to ensure their strength and their compliance with the required specifications of the project. Following inspection, the completed constructed pipeline can either be lowered into the trench if it is going to be placed underground, or the aboveground pipe bed completed etc. In the case of a local installed piping installation, versus a long-distance pipeline, the method of construction would be similar—piping blueprints would outline the location of different elements of a completed piping conduit to be installed between two points in a commercial site, and the necessary piping components would be assembled to do so. The completed piping installation could be constructed by welding or other connection of the piping components together, through or on the necessary bed, racking or other assembly inside of the facility. This description obviously far oversimplifies the construction of a pipeline but provides a general overview of the concepts from the perspective of understanding the construction workflow and testing of a piping installation.

The key construction inspection attributes of a pipeline which it is desired from an overall record-keeping and safety or integrity perspective are the details of piping components which are used, as well as strength or other types of testing even including visual review on the quality of welds or other connections between components. Careful maintenance of records with respect to all of these inspection attributes minimizes the possibility of the presentation of points of failure in the completed piping installation—particularly in large, complex installations, the complexity of these designs and the number of piping components that would be involved makes it most important to find ways to most efficiently capture that data to a central information management system. The prior approach of paper record-keeping, for either memorial purposes or for transposition into electronic information management systems is simply too inefficient and any type of information management system which would remove or at the very least minimize the need for handwritten or manual record-keeping is desirable.

### Inspection Attributes of Piping Assets

There are many inspection attributes of different piping components or component connections which it might be desired to track or maintain in a record-keeping system related to a finished piping installation. The first general category of component inspection attributes could be manufacturer inspection attributes—as outlined elsewhere herein these could include manufacturer name, plant or location of manufacture, manufacturing date or batch numbers, manufacturer serial numbers or other information assigned by a manufacturer to a component at the time of manufacture. Capturing these types of information about various piping components 1 into the attribute database 10 will allow a user to perform searches and reporting against the attribute database 10. The ability to quickly relate identified piping components or component connections with particular manufacturer or other inspection attributes could then be rapidly mapped back against the locations of those components within the pipeline as well, since that information would also potentially be stored in the database 10 with respect to each component or connection.

A second category of inspection attributes which it might be desired to track in respect of a finished pipeline project in accordance with the remainder of the present invention would be construction inspection attributes. Construction inspection attributes are contemplated to be additional measurements or other information captured with respect to the specific use of the component within the finished pipeline. For example, commissioning parameters or settings for components used in the pipeline, details of component connections between components and test results or inspections of those connections might also be considered construction inspection attributes which it was desired to track within the attribute database 10 for record-keeping or search and reporting purposes.

A third category of inspection attributes which could be tracked within the attribute database 10 are maintenance inspection attributes. Maintenance inspection attributes would be parameters, test results or other information related to the component connections as a part of the completed pipeline and which pertain to maintenance of those component connections. Similar to timing or other chronological information regarding maintenance requirements and cycles other maintenance information could be actually results or readings upon periodic testing or maintenance of the component or components in question. Any number of different types of maintenance inspection attributes could be contemplated and all are intended to be within the scope of the present invention.

Attributes, in addition to measurements which could be gathered from a component or a portion of a completed pipeline could also be calculated inspection attributes. That is to say that an attribute as stored within the attribute database 10 with respect to a particular component could be calculated by the software of the present invention, such as the automated calculation of inspection or maintenance frequencies, etc.

### Non-Destructive Examination

It is specifically contemplated that the key aspect of efficiency which will be gained in these types of record-keeping systems in accordance with the practice of the present invention is the ability to quickly and accurately capture to an attribute database the results of actual nondestructive inspection or examination which is undertaken of those components or component connections at their installation locations. For example, particular lengths of pipe assembled into a pipe string might be visibly inspected, inspected ultrasonically or otherwise to identify flaws or confirm manufacturing parameters before being signed off as completed in construction, and those inspections might take place either in the field at the point of installation of the component or even elsewhere in the manufacturing or supply chain. In addition to other parameters or inspections conducted of piping components during the course of manufacture of a piping installation, the connections between piping components are obviously also a key point of failure in a pipeline and will all be carefully inspected before the pipeline is commissioned into service. This could include any number of different types of physical inspections, noninvasive instrument inspections or the like. The system and method of the present invention will result in the creation of a complete historical inspection log for component connections or components, which can be used for reporting or query purposes.

In addition to other inspection attributes of the pipeline which it might be desired to capture, such as strength testing results, inspection results and the like, it is also desirable to link in the record-keeping system those inspection attributes to a particular connection or physical location. One of the most basic means of “attaching” particular piping components to locations within the completed constructed pipeline is to effectively measure the position of the component in relation to known reference points along the completed pipeline. Another approach which has been used occasionally in the past has been to capture GPS coordinates for the location of particular piping components and to attach those coordinates to the remainder of the information with respect to the component itself in the paper-based record-keeping system.

Capturing geo-referenced locations for individual components or component connections would also allow for graphical mapping or complete understanding of the actual geographic reference location of a particular component in the completed pipeline. It would also provide a means by which the entire pipeline down to its individual connected components can be mapped. Various location mapping or geo-referencing technologies in relation to installation locations could be used.

### Serial Marking of Piping Components and Component Connections

One of the key business concepts that would be applicable to a record-keeping system which will be rendered by the system and method of the present invention is that each component 1 or connection 4 would need to be identified by a unique identifier. The assignment of a key or identifier will be understood by those skilled in the art of relational database programming and the like. Effectively the identifier that could be assigned would comprise a “serial number” in accordance with the remainder of the system. Connections and components may share a single series of identifiers or maybe identified separately—either approach would work. In the remainder of the discussion, the ID which is assigned to a component will be referred to as a component ID 16, and the ID which is assigned to a component connection between components would be referred to as a component connection ID 21. By assigning these unique identifiers to each component or connection in the completed piping installation it is possible to attach inspection attributes and other information in the attribute database 10 to those specific locations on the pipeline.

Various types of physical markings can be conceived, by which the component ID 16 could be physically marked or attached to the piping component 1 to which it corresponds, so that during the practice of the method of the present invention, the component ID 16 can be visibly or physically located with respect to a particular piping component 1 for the sake of cross referencing and entering data to the attribute database. Similarly, physically marking the connection ID 21 with respect to a particular connection 4 on or near that connection 4 would also be required or desirable from the perspective of practicing the method herein.

In respect of an aboveground pipeline, basic embodiments of the marking of piping components 1 and connections 4 could consist of the welding or other attachment of ID plates or the like on to the components or component connections or near them, so that upon visible traveler inspection of the pipeline, the component ID 16 or connection ID 21 could be visually located on inspection for the sake of entering or cross reference into the database and the client software. Where these identifiers were physically marked on to the piping components 1 or component connections 4 for physical or manual reading, the marking might be simply a printed number or identifier which could be keyed into the client software, or it could also take the form of a barcode or some other type of a machine-readable identifier which would enhance the speed and potentially the integrity of data entry and capture of the identifiers 16 and 21 in the context of entering attribute data for the attribute database. In the case of aboveground piping installations or installations where piping more pipelines in accordance with the present invention could be inspected without the need for uncovering or unearthing them, any such method of a visibly readable identifier 16 or 21 being attached or marked thereon is contemplated within the scope hereof.

An alternate approach which is contemplated, which has utility in underground pipeline installations as well as potentially providing additional speed and data integrity benefits for aboveground or more easily accessed installations as well, is to use RFID tags or similar component markings to attach the component ID 16 or the connection ID 23 a particular asset in the pipeline. RFID, or radiofrequency identification, is the wireless noncontact use of electromagnetic fields to transfer data for the purposes of identifying tags which can be attached to objects such as pipeline components are piping components or component connections. The tags which are used in this type of a method contain electronically stored information such as a serial number or other identifier. Some types of RFID tags can be read at and powered by magnetic fields at short ranges. Other types of RFID tags which can be read from a further range or from an underground location or the like might include a power source such as a battery. Unlike a barcode or other visibly readable tag, and RFID tag does not need to be within the line of sight of the reader and to even be embedded in the tracked object. In any event, writing the component ID 16 or the connection ID 23 and RFID tag and then physically attaching the tag to the component or connection in question can allow for the ability to later acquire that information back from the tag using an appropriate reader. In addition to the component ID 16 or connection ID 21 additional inspection attributes of the component or connection question could also be written to the tag and read from the tag by the reader, rather than needing to retrieve all of that information from the attribute database. That type of an embodiment is also contemplated within the scope of the present invention.

There may be other types of technologies which could also be used, with similar effect to RFID, to allow for the wireless and out of sight acquisition of tracking information from particular piping components 1 or component connections 4 within a pipeline monitored in accordance with the remainder of the method of the present invention. All such similar approaches are contemplated within the scope of the present invention.

Referring to FIG. 2 there is shown another sample embodiment of the piping installation of FIG. 1, on which the serial identifications of the connections and components in that piping insulation are shown. Marked for the sake of this Figure in a single sequential series, the identifiers of all of these connections and components are shown as labels R1 through R12 on the drawing. Labels R2, R4, R6, R8, R10 and R12 correspond to components 1 and would be component IDs 16. Labels R1, R3, R5, R7, R9, and R11 correspond to connections of piping components in the piping installation and would be connection IDs 21. This Figure shown in this fashion simply for demonstrating one methodology for identifying the various components and connections in a piping installation, but it will be understood that many different types of serialization of the labeling of piping components and connections within a piping installation would all fall within the scope of the present invention.

It is specifically contemplated in the case of the embodiment shown in this Figure that each connection and component—and the labels R1 through R12 assigned thereto—would be represented by records in the attribute database of the remainder of the invention. The labels R1 through R12 represent both the serial identifiers attached to each component or connection as well as the physical attachment thereof to each component or connection. As outlined above there are numerous types of physical labeling methodologies which could work but various types of RFID technology are contemplated specifically for use. Using RFID technology, the serial identifiers of piping components and connections in the piping installation of FIG. 2 could be read or acquired by simply passing RFID reader near those components and their labels. As outlined elsewhere herein, a component connection between components might have its own identifier assigned or might be referenced by the reference to the specific two faces of the components being attached—either such approach could be done in a database by those skilled in the art—and modifying the serialization or tracking methodology of the present invention to behave in that fashion is contemplated herein.

### Attribute Database

The key physical aspect of the method which is required for its practice is a central attribute database 10 in which inspection and another inspection attribute records pertaining to various components and connections within a piping installation are stored in relation to their serial identifiers 16, 21.

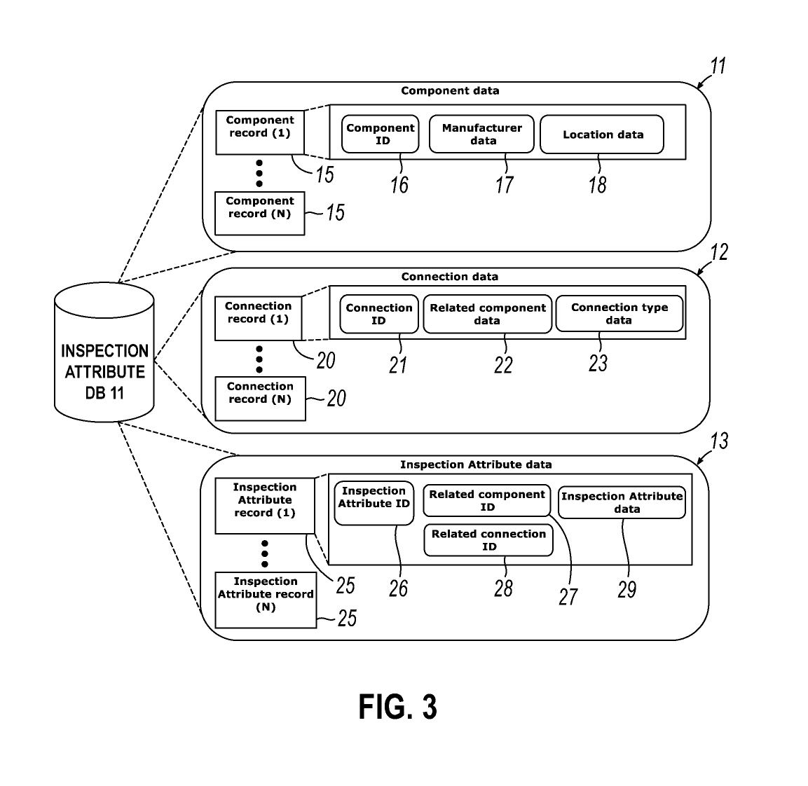

The attribute database 10, as shown in FIG. 3, contains a number of subsets of data which would be used in the execution of the method or the operation of the system of the present invention, being a component connection record data subset 12 and an inspection attribute record subset 13. Various types of data structures could be used in an attribute database 10 in accordance with the software and method of the present invention and these will all be understood to those skilled in the art. Any type of data structure capable of storing the component record data and the connection record data, along with the field captured inspection attribute information in conjunction with the remainder of the software and hardware combination outlined herein will be within scope hereof.

The attribute database 10 might be resident on a server of the present invention or might alternatively be resident on or administered remotely within some type of a server farm or database environment which was operably connected for communication with the server of the remainder of the present invention. The database 10 might also comprise multiple databases or files, rather than a single data file or structure. The particular construction or data structure of the attribute database 10 might also depend upon the infrastructure design of the remainder of the system of the present invention—again the various aspects of the system, its structure and the attribute database including those which are infrastructure dependent—and will be understood to those skilled in the art of relational database and client/server system design. It is specifically contemplated that the attribute database 10 would most likely comprise a SQL database running on the necessary database server platform. However other approaches, tools and development environments can also be used.

### Connection Data

The primary subset of data stored within the attribute database 10 is the connection record data subset 12. The connection record data subset 12 would be comprised of a plurality of connection records 20, each of which corresponded to a physical connection between two piping components, such as two adjacent lengths of pipe, or a pipe and a valve etc. It is contemplated that each connection 4 can also be treated as another piping component 1 itself and simply tracked in that fashion with the attendant modifications to the component record data subset 11 and such modifications would also be understood by those skilled in the art of database programming and design—eliminating the need for segregated record subsets with respect to piping components and their connections.

A piping component 1, such as a length of pipe or other piping component of the finished pipeline, could connect to two or more adjacent piping components—that is to say that the piping component could have more than two connection points. For example, a pipefitting, valve or the like might comprise a “T-junction” or some other type of a specialized fitting which allowed for the connection of more than two adjacent other piping components—with respect to that type of a piping component there could be more than two connection records 20 which related to the connection of such a component 1 to adjacent components 1.

The connection record 20 with respect to a particular piping connection 4 would contain identifying information with respect to the connection in the finished pipeline of two particular piping components. A unique or serial identifier with respect to the connection and the related connection record 20 would likely be assigned. The connection record 20 would also include other information identifying the type, characteristics etc. of the connection in question—for example if the connection in question in respect of a particular record 20 was a welded connection between two pipes or a pipe and a fitting, the record 20 might include information about the weld itself—the type of equipment used to make it, identity of the welder to physically made the connection, the welding material itself in terms of the type or batch of steel or joining material, date, location or time of the connection or weld, as well as other additional descriptors or parameters around the piping connection which is subject to that record 20 which could be used to refine or limit queries to select piping connections in accordance with the remainder of the present method. To implement the method of the present invention, either on a new construction pipeline project or on existing pipeline being “retrofit” into the system and method of the present invention, there would need to be a component connection record 20 with respect to each connection within the completed pipeline or the section the complete pipeline being monitored in accordance herewith.

FIG. 3 shows additional information regarding the intended data structure or layout of the attribute database 10 with respect to the connection record data subset 12 and the connection records 20. There is shown in the Figure a plurality of connection records 20, each of which would represent the necessary information to track the connection of two piping components 1 in accordance with the remainder of the method of the present invention. As can be seen, with respect to the first connection record 20 outlined in that Figure, there are a number of key fields in the connection record 20. The first field contemplated within that record 20 is a component connection ID 21, which as outlined above and elsewhere would be a serial key for the particular piping connection for tracking within the database 10 and in accordance with the remainder of the present invention. In certain cases, the connection ID 21 can be a field in the record which had multiple purposes—for example those skilled in the art of database programming might use the key in addition to as a component connection identifier 21 also as some type of a checksum or data integrity verification field, location field or the like.

In addition to a component connection ID 21, the connection record 20 could also include related component data 10. The related component data 10 is specifically contemplated to connect the connection record 20 to two specific component records 15 within the component record data subset 11 of the database 10—insofar as each connection record 20 relates to the connection of two piping components, the connection record 20 would and should connect or identify the two piping components 1 themselves which are connected in that physical connection 4 by reference to the component records 15 of those two components, likely by their component ID 16 or otherwise as will be understood to those skilled in the art.

More information which could be maintained with respect to a particular connection in the finished pipeline could be connection type data 23. Connection type data 23 might include information related to the specific type or parameters of the connection 4 itself which is the subject of the connection record 20—for example the type of welding which was used to connect the two related components 1, or other information related to the type of connection 4 made between the components in question. Depending upon the type of connection type data 23 which was desired to store within connection records 20, different fields and datatypes could be used and again all such modifications as will be obvious to those skilled in the art of database programming which be used to accomplish this objective are contemplated within the scope hereof.

Many embodiments of the present invention contemplate the marking of individual piping components with an RFID tag. Component connections 4 in the finished pipeline could be marked with their own separate RFID or other tagging mechanism, such that the connection itself between two adjacent piping components 1 would have its own serialized marking or “address” on the finished physical pipeline which can be used for identification purposes. An alternate approach rather than separately tagging or identifying the weld or connection itself would be to physically locate a particular connection 4 along the finished pipeline 6 by locating the two tagged adjacent components 1 which are connected, and which are linked to the connection record 20 of the connection 4 in question and identifying or understanding the correlation between the record 20 of the particular connection 4 in that context by identifying the two connected piping components 1 in that fashion. Either methodology to the tagging or identification of individual connections 3 in a finished pipeline 6 tracked in accordance with the remainder of the present invention is contemplated within the scope hereof.

### Inspection Attribute Data

A third data subset within the attribute database 10, which could be stored in a separate data structure or within a linked substructure connected to the component data subset 11 and the connection record data subset 12 is an inspection attribute record subset 13. The inspection attribute record subset 13 is contemplated to comprise a plurality of inspection attribute records 25 which represent inspection information from the inspection of piping components or component connections within the finished pipeline, or other information captured in respect to particular connections or components, which it is desired to maintain for record-keeping or searching purposes.

As with the other data subsets outlined above, it is contemplated that the inspection attribute record subset 13 would comprise a plurality of inspection attribute records 25, each of which pertains to a particular piping component or piping connection within a pipeline being tracked in the attribute database 10. The inspection attributes themselves which might be tracked could require the use of different data types within the inspection attribute records 25 or in related data repositories in or connected to the database 10. Again, in its broadest context an attribute of a particular connection or component which it was desired to track for record-keeping or other purposes in accordance with the remainder of the present invention could comprise really any piece of information with respect to those entities, and the necessary modifications can be made to the database 10 to track that information as well as to query it for reporting or record-keeping or location purposes.

Each inspection attribute record 25 would be related to one or more connection records 20 s 15. Also shown is the actual attribute data 48 itself which is desired to be stored within or in respect of the particular inspection attribute record 25 again as with the other data subsets in the database 10, this Figure is intended to show from a demonstrative perspective the types of information which are contemplated to be stored within the high-level method of the present invention.

Virtually any type of attribute could be tracked within the attribute database 10 of the present invention—the types of data which might be stored as inspection attributes of piping components could be text, numeric entries, or even media files or data such as photographs, videos or the like. All types of data or media which can be captured at a remote client device and stored within a relational data structure will be understood to those skilled in the art.

The server software used to administer and interface with the attribute database 10 might also be programmed with a customization interface which would allow the user to create their own ad hoc inspection attributes for tracking, which might allow a particular project or operator to further tailor or customize their record-keeping system in accordance with the remainder of the present invention, by allowing for the creation of the necessary fields and modifications in the data structure of the attribute database.

Results of inspections or other attribute capture could either be stored directly to the attribute database 10 of the present invention in a format acquired from the instrumentation used to conduct them, or could be directly entered into a data entry screen or interface by a field worker at the point of inspection or capture of the information using a mobile wireless device, rather than capturing that information on a paper-based form for later paper-based filing or transcription at a later time into a central record-keeping system.

The system and method of the present invention will result in the creation of a complete historical inspection log for component connections or components, which can be used for reporting or query purposes.

### Pipe Component Data

A component record data subset 11 is the first set of data which could be stored within the structure of the attribute database 10, which would be required for the execution of the present invention. The component record data subset 11 would be comprised of a plurality of component records 15, each of which component records 15 corresponded to a piping component, and which would in combination with other components 1 yield a completed piping installation 6. FIG. 1 demonstrates one small sample of a piping installation for discussion purposes.

Referring to FIG. 3, there is some additional information shown to further outline the intended data structure or layout of the attribute database 10 with respect to an embodiment containing piping component records. There is shown a plurality of component records 15, each of which would represent the necessary tracking information to track a piping component 1 with respect and in accordance with the remainder of the method of the present invention. As can be seen, with respect to the first component record 15 outlined in that figure, there are a number of key components in the component data record. The first item intended or contemplated within that record is a component ID 16, which as outlined above and elsewhere would be a serial key identifying the particular piping component for tracking within the database 10 and in accordance with the present invention. In certain cases, the component ID 16 could be a field in the record which had multiple purpose.

Many of the embodiments of the present invention outlined herein contemplate the marking of individual piping components 1 themselves with an RFID tag. The RFID tag might have its own unique identifier which could be used as or in conjunction with the serial key of the record 15 corresponding to that particular piping component. Another identity approach which could also be taken with respect to piping components 1 and the remainder of the system and method of the present invention would actually be to place an RFID tag or similar identifier at each end of a piping component—for example each end of a piece of pipe used in the pipeline construction could have its own RFID tag or identifier placed thereon. This type of an approach might be considered desirable by some in terms of best yielding a cross referenced attribute database 10 where individual connections identified and stored within the connection record data subset 12 could actually identify the specific piping components which they connected by the specific end or attachment point of the pipe or other component. In certain cases, some piping components may actually have more than two connection faces or ends—in this type of an embodiment, each connection face or end could have its own identifier or tag placed thereon. In the case of more than one tag or identifier being used on a single piping component, there would be a need to make some modest adjustment to the data structure of the attribute database 10.

In addition to a component ID 16, the component record 15 could also include manufacturer data 17 with respect to the particular piping component in question. The manufacturer data 17 as outlined above could include indications of manufacturer, serial number from the manufacturer of the particular component, manufacturing batch or location or any number of other types of information which it would be desired to capture with respect to the identification of the piping component for subsequent reporting, record keeping or searching purposes.

In addition to manufacturer data 17 and other types of information which it might be desired to store for record keeping purposes with respect to a piping component related to a component record 15, another integral piece of information which it is contemplated will be stored with respect to the component within its related component record 15 is location data 18. The location data 18 would be a field or fields within the record which stored information related to the relative location of the component within the constructed pipeline and/or the actual georeferenced location of the component, which might be a set of GPS coordinates or other similar type of GIS related information. The location data 18 could be captured using any number of different types of technologies as outlined elsewhere herein, and it will be contemplated that the necessary modifications to the structure of the portions of the database 10 and the component records 15 which are intended to store that information are all contemplated within the scope hereof as well.

As outlined herein, each component would have at least one connection point for connection to an adjacent component—the details of those connection points for connection faces would make up a portion of the component record 15 or related information stored with respect to each component record 15 as well.

### Method Overview

Various types of data and inspection attributes are stored within the attribute database 10 with respect to piping components 1 or component connections 4 between piping components 1, including location data with respect to the connections and components, such that components and connections can subsequently rapidly be located in the field, and fieldworkers can directly capture and enter all of this information to the attribute database by a user interface on a wireless device, rather than the need to capture the various information to a paper-based format for subsequent filing or subsequent transcription into an electronic information system.

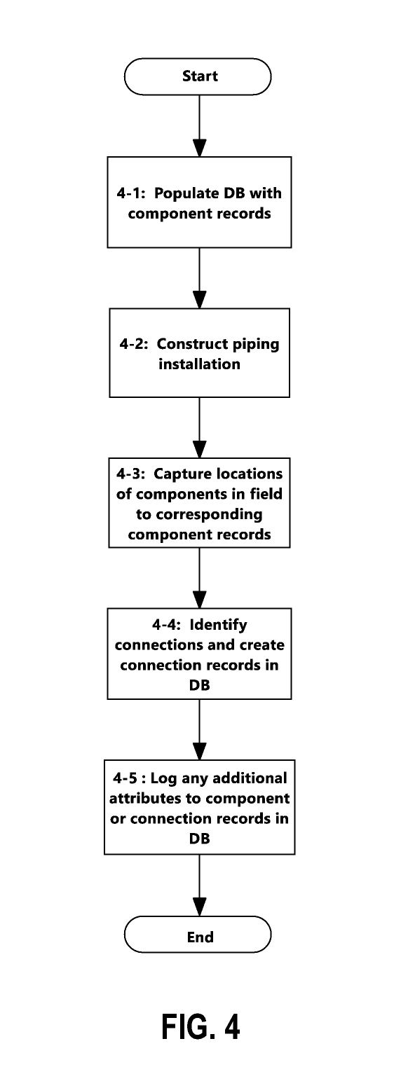

In the embodiment of the method demonstrated by the flowchart of FIG. 4, the first step which is shown is the population of the attribute database 10 with a plurality of component records 15 corresponding to the components 1 to be used in the construction of the particular piping installation. As outlined elsewhere herein it is contemplated that there would be two methods of pre-populating or loading large batches of component records 15 into the database 10. The first of these would be to provide batch manipulation and import facilities by a central management console, or even to provide a client/server interface by which vendors providing components 1 for use in a particular piping installation construction project could be required or provide services by which they would preconfigured or preload the component records 15 corresponding to the products and components 1 to be provided by them into the database. It is also contemplated that in the field it may be possible in certain embodiments of the method of the present invention to allow for the client software or client interface on the field device to have the ability for a field operator to, in the field, create a component record 11. It can even be envisioned that the component records 15 might be most desirably created during construction by the field operators—there are many different approaches which could be taken here but the most likely approach would be to populate the database 10 with component records 15 which were at least partially populated with inspection attributes and data related to their related components 1, and field entry of additional inspection or attribute information could then be tagged on in the database as well during operation or the subsequent use of the system. Population of the database 10 in this fashion is shown at step 4-1.

A portion of the creation of the component records, shown at step 4-1, would also comprise physically identifying the components in respect of which component records 15 have been created—by attachment of an RFID tag, bar code, written label or other information to the component, so that the component identifier 16 which matches up to a record 15 in the database 10 could be accessed by entering or capturing that component identifier 16 in the field and entering it into the data system so that the remainder of the method could be practiced, attaching inspection attributes and other information related to that component into the database 10. Again it will be understood that differing approaches could be taken to the substeps within step 4-1—for example, the manufacturer could pre-label all of the components 1 which they would provide with a serial identifier which could simply be grabbed and used as the component identifier 16 in the creation population of the related record, or identifier specifically created for the purpose of the practice of the method of the present invention with previously attached or attachable to component records within the database 10 could be used and attached to components—and as a part of the attachment process could effectively be removed from an available inventory of unused identifiers and attached to a record and corresponding component in the database 10.

The next step shown in the method of FIG. 4 is the construction of the piping installation—shown at 4-2. Construction of the piping installation would actually comprise the connection of various components 1 which would have or have created for it at this time corresponding component record 15 within the database 10. While there is obviously more to it than this, the basic construction of a pipeline or piping installation as outlined above comprises the serial connection of piping components 1, by connections 4. As or during the construction of the piping installation, the location of individual components 1 in the field where they are used would be captured, and tags to the corresponding component records 15 in the database 10 physically how this would be done it is contemplated that using a field data entry device, a field operator would capture, by typing, scanning or otherwise acquiring from the component in question, the component identifier 16 from a component. The client device software could include data checking function where it was verified that there was a record 15 in the database 10 as well. Either automatically by capturing a GPS fix or otherwise, the client software could capture or acquire as a data entry from the operator a location reference for the component 1 in question, and the location of that component 1 in relation to other components and in relation to the piping installation as a whole could be stored back to the corresponding component record 15 in the database. Before, during or after construction, but following the creation of the initial tombstone data and component records 15 in the database 10, additional inspection attributes of the individual components 1 could similarly be uploaded for storage in relation to the corresponding component record 15, by a data interface that again would allow for the capture, entry or acquisition of the component identifier 16 in respect of which the data should be captured, and then allowing the operator to enter whatever attribute information was desired—photos, numerical readings, or the like, and uploading that for storage in the inspection attribute subset of the database 10. Thematic here is the fact that every time it is desired to capture in the field some attribute or other information related to a particular piping component 1, or a component connection 4 as outlined next, a presumably client device will be used which will allow for the entry or acquisition of the related identifier for that record in the database and then allow for entry of the information, which will then from the client device be uploaded to the server for storage in the database 10 in relation to the record in question. This method will remove the need for manual record-keeping.

An alternate approach to capturing the location of piping components in a finished piping installation to that shown in step 4-3, where the location is captured as a data entry step during or just following construction, would be to use the method of automated capture of a pipeline asset inventory outlined elsewhere below, whereby specifically if the components and connections were marked with RFID or otherwise readable markings or tags, a location index of all the components and connections along the piping installation could be acquired at any time by simply taking a client device along the entirety of the piping installation and acquiring in sequential order each component ID or connection ID encountered, and capturing at that time I GPS or other location fix using the hardware and software and the client device for storage to the attribute database in relation to the corresponding record for each component ID or connection ID. Both such approaches are contemplated within the scope of the present invention.

As outlined, the key aspect of construction of the piping installation at least from the perspective of the present invention is the connection of adjacent piping installation components 1 to each other, to form the material conduit or otherwise complete the piping installation. As components 1 are connected together, each connection 4 would be identified, within the scope of that terminology in the present invention, and a component connection record created within the database 10. Identifying the connection 4 would comprise either the attachment of an additional serial identifier or label to or near the connection of two components 1, or in alternate embodiments, information with respect to the connection of two components could I should be stored in relation to the remainder of the data for each of those components. It is contemplated that the primary method by which this would be done would be the treatment of the connection 4 as its own entity in respect of which additional information and inspection attributes could be tracked, either within the same data set as the pipeline components 1, or in a component connection dataset 12 as is shown in FIG. 3. Following or during connection of two components 1 in the field, and operator with a client device would effectively, as shown at step 4-4, create a component connection record 20 within the database 10, which would again comprise the assignment or attachment of a component connection ID 21 in respect of that individual or discrete connection 4, as well as intentionally capturing the location or other identifying information with respect to the connection 4 and uploading all of that for storage in respect of the particular connection 4 in the corresponding connection record 20. Connection records 20 would also in all likelihood indicate the component ID 16 of the two components 1 which were connected at that connection—which provides the ability for additional cross referencing and query in the attribute database 10 as might be desired or required for reporting purposes.

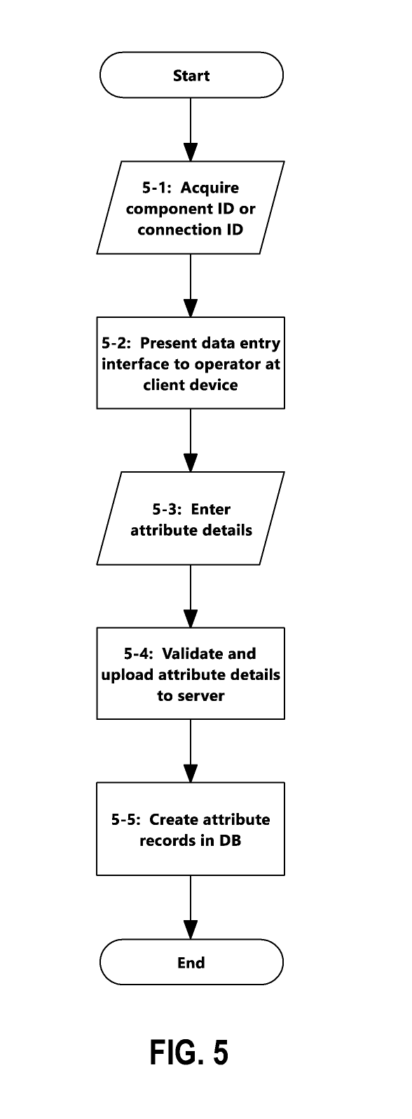

Following step 4-4 the construction and basic operational population of the database with respect to the piping installation would be complete. Also shown in this FIG. 4-5 is an additional datalogging step—this would constitute the capture and storage of field inspection or attribute information to the related records in the attribute database 10. Effectively what is contemplated and will be outlined in further detail herein is that a client device could be used by a field operator to make data entry with respect to inspections conducted of particular piping components 1 or component connections 4. The operator at the client device by the user interface thereof would enter or otherwise capture the component ID 16 or the connection ID 21 with respect to the particular component 1 or connection 4 in respect of which an entry was desired to be made, and then the user interface would provide whatever additional guidance or functionality was required for the operator to via the user interface of the client device enter inspection attributes or inspection readings etc. Following the completion of the entry of inspection attributes by the operator at the remote client device, the client device would communicate that information back to the central server for storage in the database 10 linked or related to the necessary or desired component or connection records.

Following the completion of a method of field-based capture of piping installation inspection and other attribute information, approximately as demonstrated in FIG. 4, related to connections and components within a piping installation, there will be assembled in a central attribute database 10 a complete data set which is locationally referenced which includes all of the desired inspection attributes and inspection information desired to be captured with respect to individual components or component connections in a finished piping installation. The method of the present invention, allowing for a remote client-based data entry process, allows for field operators to directly enter and validate for storage to the database attribute information which can then be transmitted for storage in the database without the need for any transcription, transposition or duplicated data entry steps. It is also explicitly contemplated that a locationally referenced data set including the desired inspection attributes or information to be tracked with respect to components and connections within a completed piping installation, assembled in accordance with the method of the present invention allowing for field-based data entry, is also within the scope of the permissible subject matter of the present invention and is explicitly contemplated to also be covered herein.

FIG. 5 is a flowchart demonstrating the steps of one method in accordance with the present invention for the storage of attribute information to the attribute database 10 in accordance with the method of the present invention, from a field operator and a related client device. What is contemplated is that in accordance with the system and architecture of the present invention, an operator in the field seeking to inspect and/or enter attribute inspection data from a periodic inspection of one or more pipeline components or component connections would have client device in accordance with the remainder of the invention outlined herein which was operatively connected via a network for communication with the attribute database 10.

Using the client device, the operator would enter or acquire the component ID or the connection ID of the component or connection in respect of which they wanted to enter attribute information to the database. The client device would present a data entry screen of some kind to the operator for entry of this ID information. The ID could be entered either by manual data entry on the client device based on reading the related component ID or connection ID off of the component or connection question, or in certain cases the device may actually read an RFID tag which was in place on the component or connection so that the ID in question would be automatically captured. A barcode is another method of automatic capture which would also assist in the streamlining of data entry and its integrity. Step 5-1 shows the acquisition of the relevant component ID or connection ID at the client device.

As will be outlined elsewhere herein, it is contemplated that either by way of a locally installed client software or by a client/server browser interface, the client device will be in dynamic communication with the server in the database. Upon acquisition of a component ID or a component connection ID, shown at step 5-1, that would be transmitted to the server by the client device. That would be used by the server to identify related information and a corresponding component record or connection record in the database to which following entered attribute information was to be tagged are connected. Standard data checking in verification could be coded into the software at this time or juncture in the workflow. Based upon the component ID or connection ID that was entered, the server could serve, and/or the client device could select, the appropriate data entry interface to display to the operator at the client device for entry of the inspection attribute information. This is shown at step 5-2. This might for example based upon identifying whether it was a component connection ID or a component ID that was entered, present menu to the user which allow them to select from one or more data entry screens through which different types of attribute information would be entered etc. The user interface at the client device would in any event display directly or by menu selection or other interaction with the operator one or more data entry forms into which attribute information could be entered.

Step 5-3 shows the entry of attribute details into one or more data entry forms via the user interface of the client device. It is contemplated that the data entry forms would either present fields into which the operator could enter different inspection results, menus from which particular inspection attributes could be chosen for standardized communication and storage, or other interfaces with the input and output hardware on the client device so that for example photos or videos or audio files could be captured, locations can be captured or the like. Various types of data entry interfaces can be contemplated, and all such modifications are contemplated within the scope hereof insofar as they all contemplate the entry of attribute details for storage with respect to the particular component or connection in question. Attribute details captured at step 5-3 might also comprise data which was captured automatically by the client device or by input output hardware attached by a communications bus to the client device.

Following entry of the inspection attribute details question by the user, shown at 5-3, either at the client device or server end, that attribute information can be validated as required and uploaded to the server for storage. This is shown at step 5-4. Upon receipt of a packet containing attribute details from a client device, corresponding to a component ID or connection ID in the database, the server and related software therein could create the necessary inspection attribute records in the database 10 for storage and eventual retrieval. This is shown at step 5-5. This Figure shows just one of many possible approaches which could be taken to data entry in accordance with the overarching method of the present invention, which is to allow for the infield data entry of attribute information for storage back to an attribute database in respect of one or more pipeline components or component connections, without the need for manual record-keeping.

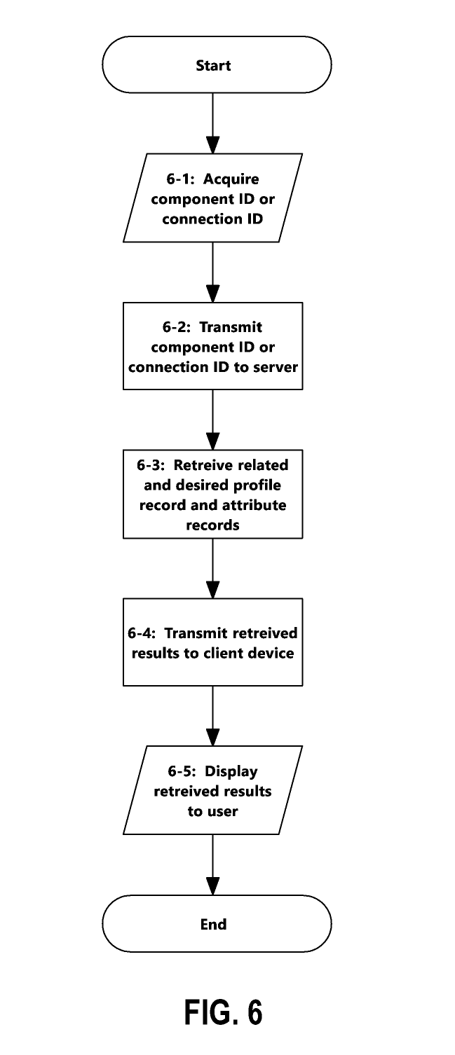

FIG. 6 is a flowchart demonstrating the steps of one data retrieval method in accordance with the present invention, wherein operator with a client device in accordance with the remainder of the architecture of the present invention could retrieve record data or attribute data from the central attribute database 10 for viewing on their client device. It might be desired for maintenance or construction workers in the field during construction or maintenance of a piping installation using the system and method of the present invention to be able to retrieve various status, attribute or basic information from the records stored with respect to a particular component or connection within the database.

In accordance with the method outlined in this Figure, a field operator would have a client device operatively connected to the remainder of the proposed architecture of the present invention. In accordance with the system and architecture of the present invention, an operator in the field seeking to retrieve attribute inspection data or other record contents with respect to a component or connection from the database would have a client device in accordance with the remainder of the invention outlined herein which was operatively connected via a network for communication with the attribute database 10. Using the client device, the operator would enter or acquire the component ID or the connection ID of the component or connection in respect of which they wanted to enter attribute information to the database. The client device would present a data entry screen of some kind to the operator for entry of this ID information. The ID could be entered either by manual data entry on the client device based on reading the related component ID or connection ID off of the component or connection question, or in certain cases the device may actually read an RFID tag which was in place on the component or connection so that the ID in question would be automatically captured. A barcode is another method of automatic capture which would also assist in the streamlining of data entry and its integrity. Step 6-1 shows the acquisition of the relevant component ID or connection ID at the client device.

Following acquisition of a relevant component ID or connection ID at the client device, step 6-2 shows the transmission about ID information to the server by the client device. Based upon receipt of a view or retrieval request from a client device such as this, the server, shown at step 6-3, would retrieve the desired and related record and inspection attribute records from the database. There would presumably in the interface presented to the operator of the client device be one or more data display screens or other interface which would allow for the display of the retrieved information to the user. Shown at step 6-4 is the transmission of the retrieved query results from the database back to the client device, for display shown at 6-5 other retrieve results to the user. Many types of data retrieval methods and benefits can be contemplated within the overarching scope of the present invention and again all such modifications or extensions of the method of the present invention as outlined herein are contemplated within the scope hereof.

### Illustrative Environment and System Architecture

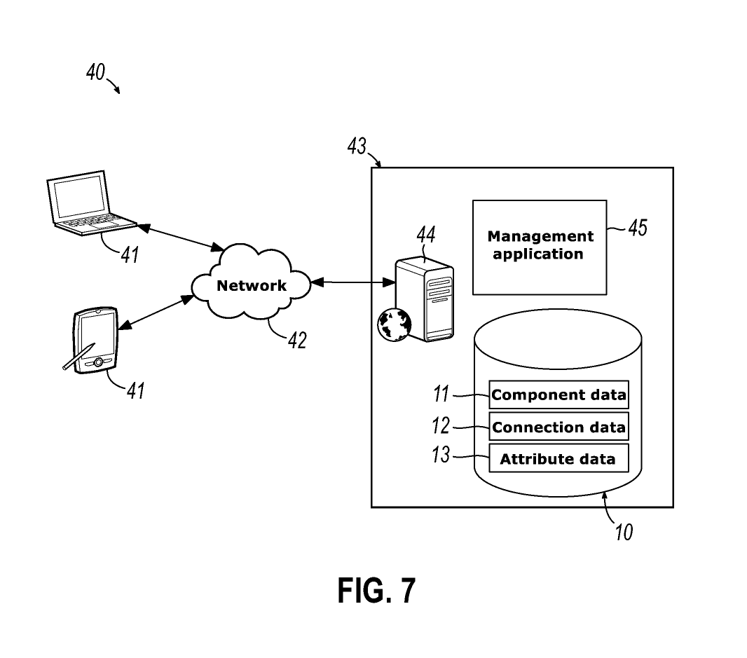

FIG. 7 shows an illustrative architecture of the overall system 40 of the present invention, in which representative field workers can use mobile client devices 41 to interact with a piping installation record-keeping system and provider 43. The system provider 43 would comprise or operate a server 44, which might include various software applications to manage interactions between the system or provider 43 and the client devices 41. The software applications on the server 44 would include piping attribute management software 45, responsible for the administration and handling of the method of the present invention. The server 44 would also host an attribute database 10, accessible to the software applications thereon, which would contain database records or information corresponding to piping components, connections and inspection attributes thereof as otherwise outlined herein—the attribute database 10 along with the component data subset 11, the connection record data subset 12 in the inspection attribute record subset 13 are shown herein for demonstrative purposes.

The client devices 41 would be locationally aware, or able to provide information to another entity i.e. the server 44 to allow the other entity to determine the location of the client device 41. A location on the surface of the earth, or a “geolocation” may be provided to the client device 41 by one or more satellites etc. Alternatively, wireless signals such as from a radio antenna might be used to determine the geolocation of the client device 41 relative to a known position of the radio antenna or antennae. Other technologies and methods of determining the geolocation of a client device 41 are also envisioned within the remainder of the scope of this disclosure such as, for example, calculating geolocation based on a network access point or from a locator signal broadcast from a known location such as the system 43.

The client device or devices 41 and the provider 43 may connect to a communications network 42. The network 42 might include any one or combination of multiple different types of networks, such as cable networks, local area networks, personal area networks, wide-area networks, the Internet, wireless networks, ad hoc networks, mesh networks and the like. In some implementations, the satellite or radio antenna used for geolocation purposes might also provide network conductivity to the mobile client devices 41 in addition to providing geolocation.

The server 44 may house or otherwise have a component connection to one or more data stores of various information required for the operation of the method of the present invention. Specifically, the attribute database 10 would be operatively connected accessible thereto and there are a number of subsets of data profiles stored within the attribute database 10 which it is desired to maintain in accordance with the remainder of the method of the present invention.

### Illustrative Server

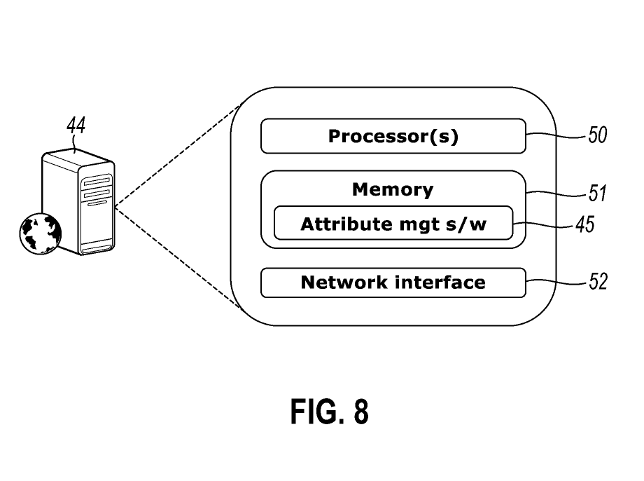

The primary means of delivery of the method of the present invention would be by way of a client/server software or website interface, which would rely on client devices 41 in the field, capable of interacting with a server 44 via the network 42. FIG. 8 outlines an illustrative embodiment of the server 44 the present invention. One or more servers 44 might be implemented in the method of the present invention is a single computing device—a server farm for example or distributed or cloud computing figuration. The server or servers 44 comprise one or more processors 50 and memory 71. The memory 71 might contain various software components and processor instructions for use in the method of the present invention or otherwise in the operation or servers 44. The piping attribute management software processor instructions stored within the memory 71 are shown at 45.

The server 44 is operatively connected to the attribute database 10. In addition to general operating system instructions and the like, the server 44 would comprise a tracking software45 which is outlined in further detail herein. The application 45 would be responsible for the execution of the method of the present invention. The tracking software45 might itself act as the interface between the remainder of the hardware and software of the server 44 in the database 10, or the server 44 might alternatively include an additional software interface to the database 10 with which the tracking software45 and its various subroutines could communicate.

The tracking software45 would comprise a plurality of subroutines, for the purpose of administering the database; creating and modifying in interaction with fieldworkers, component records, connection records or inspection attribute records in the database, as well as executing searches and reporting against the attribute database via a user interface for that purpose in accordance with the remainder of the method of the present invention. The details of the operation of the tracking software45 and its subroutines are detailed functionally below. Also shown in the Figure is a network interface 72—the network interface 72 could again be any wired or wireless interface using a network protocol allowing server 44 to communicate with the client devices 41 over a wide or local area network 42.

### Illustrative Client Device

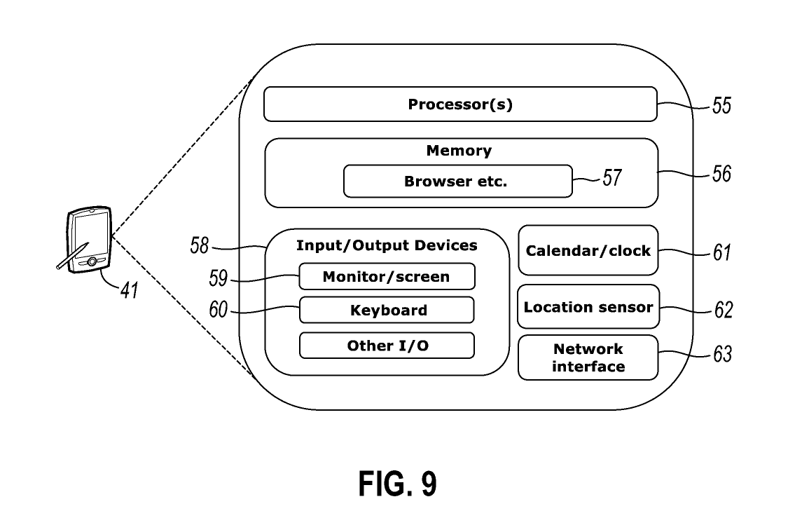

FIG. 9 is a schematic representation of the client device 41 of FIG. 7. The client device 41 includes one or more processors 55 and a memory 56. Similar to the memory on the server 44, the memory of the client device or devices 41 might include various types of processor instructions either for assistance in the execution of the method of the present invention or for other activities to be undertaken with respect to the client device. The memory 56 may include a software module such as a browser or other software 57 which is installed for the purpose of communicating with the server 44 and the remainder of the system operated by the provider 43, for implementing the method of the present invention.

Certain embodiments of the method and system of the present invention might be developed for the provider for implementation as a secure client/server or website system, where interaction by fieldworkers with the central system of the provider 43 were undertaken through interactions with a secure website operatively connected to the attribute database 10—one of the benefits to this type of an implementation would be that the type of software required at the client device 41 would be very straightforward. However, it will also be understood that in certain cases it may be desired to develop a purpose built application for installation in the memory 56 of the client device 41, which would use the components and network interface of the client device 41 to connect and communicate with the server 44 and the remainder of the provider system for the purpose of sending and receiving information to and from the attribute database 10 from the field. Either approach to the overall network architecture contemplated for the present invention as well as the software to be used on the client device 41 is contemplated within the scope hereof.

The client device 41 also includes one or more input and output devices 58. This particular Figure shows the presence of a monitor or screen 59, some type of a keyboard 60 or other means by which the user of the device 41 could interact with and enter information for capture to the attribute database 10, as well as other input-output devices. In some implementations the client device 41 might also include a clock 61, a location sensor or interface 62, and a network interface 63 would also be present.

The network interface 63 would be configured for wirelessly communicating with the network 42. The network interface 63 might use any standard protocol for network communication depending upon the network infrastructure in question. In some implementations the network interface 63 might use an antenna to send and receive data from the network 42. The network interface 63 might also in certain circumstances provide information to the hardware within the client device 41 including the location sensor 62 from which the location sensor 32 can calculate the geolocation of the client device 41.

Many different types of client devices 41 can be used in association with the present invention. As outlined, the key concept with respect to the types of client devices 41 which can be used in the method of the present invention is that wireless devices could be used to allow for field entry of inspection attributes of piping components and connections to the attribute database 10 through the remainder of the system of the present invention. Most desirably, the client devices 41 could be non-purpose built hardware, using pre-existing communication networks—such as tablets, smart phones or portable computers connected to wireless data networks. Use of nonspecific hardware in this fashion would allow for the installation of additional software components for the practice of the method of the present invention on pre-existing hardware and non-purpose built hardware. Any type of a computing device which was capable of interaction with the remainder of the system of the present invention and interaction with the server 44 and the remainder of its associated components via the network 42 are contemplated within the scope hereof.

### Tracking Software

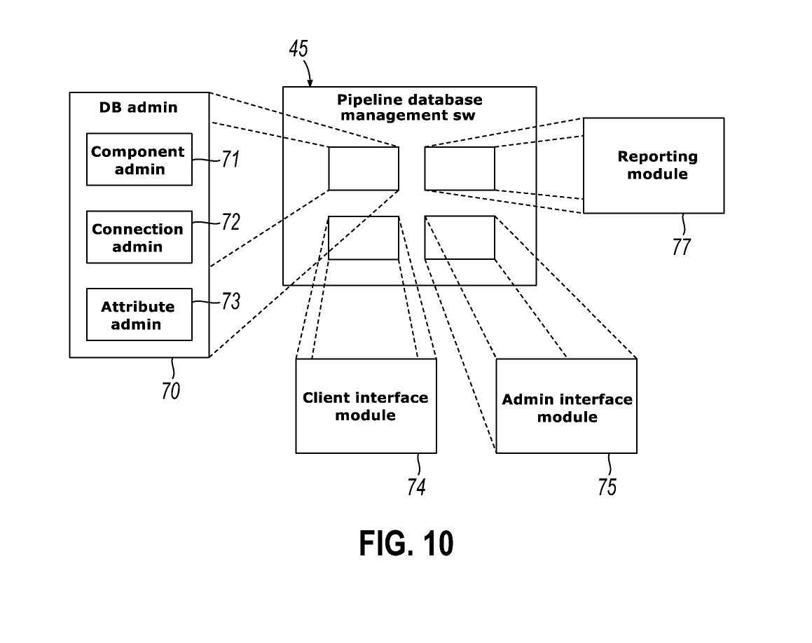

Another key aspect to the implementation of the method of the present invention is the inclusion of tracking software 45 in the software instructions resident on or accessible to the server 44. FIG. 10 shows the key components or subroutines which would be contained within the piping attribute management software application 45. In practicing the present invention it is specifically contemplated that the functions of the application 45 would include creation and administration of records in the attribute database 10, interaction with the client devices 41 via client software thereon, for the purpose of display of information from the attribute database 10 to users of client devices 41 in the field as well as for receipt of attribute data 13 or other information for upload from client devices 41 and their users to the attribute database 10. It is also contemplated that there would be a query and reporting interface either within the software application 45, or accessible to the database 10. Each of these software modules could be freestanding software applications or subroutines within the memory or storage of the server, or alternatively they could each be functions in a consolidated software program and both such approaches will be understood to be within the scope of this application.

Overall the creation and administration of records within the attribute database 10 would be conducted by a database administration module 70. The database administration module 70, through at least three subroutines or substructures, would be responsible for the administration of records in the various subsets within the database 10. There is shown a component record administration module 71, connection record administration module 72 and an inspection attribute record administration module 73.

A component record administration module 71 would be responsible for the creation or administration of component records 15 within the pipeline component data subset 11. The database administration software module 70 could, in addition to the possibility of being a purpose built software application, also comprise a layer of software instructions created for use in Association with the pre-existing database tool. The component record administration module 71 would be responsible for writing and retrieving records to and from the database 10 that related to component records. This module might also work in conjunction with other software modules for the purpose of querying or reporting from the database. Many different types of database administration approaches will be understood to those skilled in the art of database programming and all such approaches are contemplated within the scope hereof.

Similar to the component record administration module 71 it is also contemplated that there would be a component connection administration module 72 responsible for the creation or administration of connection records 20 in the database 10, as well as an attribute administration module 73 responsible for the creation and administration of inspection attribute records 25 within the database 10.

Either within the software modules or elsewhere in computer storage accessible to the processor and memory of the server are interactive web forms or other client software instructions or information which could be required for a field user with a client device 41 to interact with the piping attribute management software application 45 for the purpose of updating, creating or otherwise manipulating this data.

In addition to the overall database administration module 70 and related subroutines, responsible for interfacing with the data structure of the attribute database 10 and the other aspects of the software and user interface in the server 44 or related and connected client devices 41, the processor instructions accessible to the server 44 in the attribute inspection software 45 would include a client interface module 74. The client interface module 74 might comprise necessary processor instructions for the server 44 to interact with one or more client devices 41 via the network. If the client devices 41 were using a locally installed client software program, the client interface module 74 might effectively and primarily comprise a server to send and receive data to and from the attribute database 10 to those client devices 41. Alternatively, if the system of the present invention were executed as a secure client/server website system, the client interface module 54 might include the necessary software to allow in a traditional client/server website context of the interaction between a client browser at a client device 41 and the server 44. In addition to processor instructions the client interface module 74 might also include web forms, media or other data which was required to engage and sustain a communication session with a client device 41.

Also shown is an administration interface module 75. There would be a need for at least one administration interface, either for the purpose of querying data from the attribute database, administering the database 10 or otherwise interacting either with the database 10 or the client devices 41 during the delivery of the remainder of the method of the present invention. As in the case of the client devices 41, the administration interface module 75 might comprise a freestanding software client or client component which could be used to interact with the user via the user interface of a client device or another computing device connected to the server. The administration interface might also be accessed directly through user interface of the server 44 itself. Alternatively, the administration interface module 75 might again comprise the necessary software instructions and data to accommodate the delivery of the administration interface by a traditional client/server browser interface and both such approaches again are contemplated within the scope of the present invention.

Also shown is a reporting module 76. It is explicitly contemplated that one of the benefits of the system of the present invention would be that not only would the method allow for the rapid and reasonably streamlined capture of pipeline inspection attributes and inspection data from field operators using client devices 41, but that it would also by virtue of the fact that the inspection attributes and inspection data would be captured and correlated to records in the attribute database 10 allow for a very rapid ability to either on a programmed or ad hoc basis conduct queries against the entire dataset related to a particular pipeline or piping installation for the purpose of identifying components or component connections therein by inspection attributes, locations or the like. The reporting module 76 might be something custom programmed, or it might also comprise or optionally alternatively comprise a reporting system which could be purchased and/or connected are programmed in relation to the attribute database 10.

One of the key benefits of the method of the present invention is that since both component records and connection records stored in the database 10 would include geo-referenced location information, any reporting that was pulled from the database could include those geo-reference coordinates so that the components or component connections in question could be quickly located along the routing of the piping installation including by using the location only aware client device or devices 41.

### Client Software

Insofar as the method of the present invention is built around the ability of fieldworkers to remotely communicate pipeline inspection data and inspection attributes for storage of attribute database 10, the mobile device 41 used by field workers would need to include a software program which was capable of interacting with the remainder of the system of the present invention. It is contemplated that this could take one of two approaches, either a freestanding and proprietary client software 57, capable of communicating via the network 42 with the server 44 and the database 10 resident thereon along with the various software components 45 on the server, or alternatively some embodiments of the present invention might use a client/server browser approach, whereby the server 44 would be a Web server with the necessary authentication components to provide for secured and authenticated communication between fieldworkers and the attribute database 10 using conventional client/server or server and browser communications and data interface techniques. Either such approach is contemplated within the scope of the present invention—the basic requirements of the client software 27 would be the need to be able to interact with the remainder of the software and hardware components resident on or connected to the client device 41 at the appropriate time to read or capture component ID 16 or connection ID 21 information and provide for the ability to interact by way of data entry forms or the like for the provision of attribute data for upload for saving to the attribute database 10 in respect of a particular component record 15 or connection record 20. In certain cases, the client software used by or accessible to the client device 41 would also provide the ability to retrieve attribute or other information from the database 10 accessible to the server 44, by acquiring and transmitting a component ID 16 or connection ID 21 from the client device 41 to the server 44 and the related software 19.

It is primarily contemplated that the client software 57 used in accordance with the method of the present invention would be a freestanding local application on the client device 41—by creating a freestanding local application on the client device 41 there would be numerous benefits including the fact that the client device 41 would then not need to have constant wireless network conductivity since it could store and off-line subset of necessary pipeline database information, as well as that some of the functionality which would be desirable in certain embodiments of the system and method of the present invention would be better delivered in a local application. However, website implementations of the method and software of the present invention are also intended to be covered.

In addition to certain embodiments of the client software and the remainder of the system of the present invention providing the ability to do impromptu query reporting from a client device 41, there may also be in certain iterations of the client software 57, in conjunction or coordination with the server 44 and the software components thereon, the ability to provide access to certain “canned” queries and reports which might be useful or required from time to time during construction or maintenance applications—those reports could either be called to the client device in a static, or there could be preprogrammed query and report formats available within the server which could pull dynamic or live data from the database for display in a predetermined format, based on the most up-to-date contents of the database including all of the records therein.

It is important in piping construction applications to keep track as accurately and contemporaneously as possible of all of the connections which are made so that they can be inspected by follow-up inspection crews on a timely basis. By providing a client software operatively connected to an attribute database which is simple enough to use that welding crews in the field can lock down welds or piping connections into the system as soon as they are completed, additional workflow, or inspection notification to other inspectors or audit personnel elsewhere on the system can be triggered so that the follow-up inspection of these welds or component connections can take place in a timely fashion for example before the pipeline is buried or put into service. In certain prior art methods where manual inspection record-keeping was relied upon, it could be the case that certain welds were missed in inspections of piping manufactured or connected and this will assist in minimizing this business problem. Workflows associated with manufacturing and inspection in this fashion are described elsewhere below.

### Populating the Database

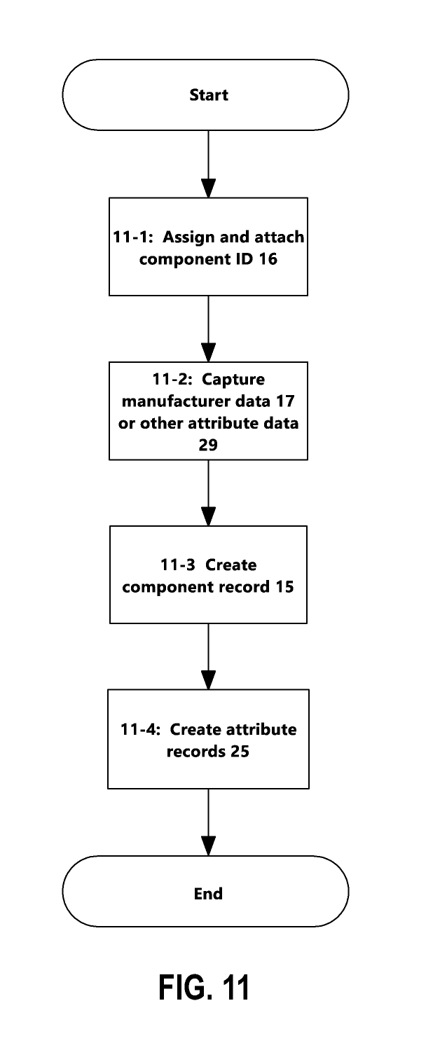

FIG. 11 is a flowchart which shows the basic steps involved in the initial population of component records 15 within an attribute database 10 in accordance with the remainder of the present invention.

A component record 15 will need to be created for each piping component 1 to be used within the construction of the pipeline or section of pipeline to be monitored in accordance with the record-keeping system and method of the present invention. These component records 15 could either be created on the fly by fieldworkers during construction, through the user interface of their client device, or they could be started or pre-populated elsewhere in the system or method such that there was less data entry to be done by fieldworkers, and with more of the information pre-populated the user interface for the fieldworkers would be able to provide a more consistent data entry experience etc. Provision of a user interface by which a field worker could completely remotely create a component record 15 within the attribute database 10, as well as a centrally loaded system, where some or all of the component records 15 were first assigned or pre-populated from a central management console or central data entry operation, are both contemplated explicitly within the scope of the present invention and it may in fact be the case that it was desirable to provide an implementation of the software method of the present invention which would accommodate or allow for both approaches that is to say that the majority of the component records 15 would be pre-populated or created centrally, with the ability for a field worker with appropriate permissions or security in the system to create a component record 15 remotely if they had a need to do so.

Creation or pre-population of component records 15 within the attribute database 10 will be a reasonably straightforward process. The key aspect of the creation or pre-population of these records will be the assignment of a component ID 16—the component identifier 16 would effectively be the serial number or other identifier which was used in the context of the attribute database 10 to attach any information respect to that particular piping component 1. The importance and framework for the creation of unique component identifiers 16 will be understood from a relational database programming perspective by those skilled in the art. The component identifier 16 might be the manufacturer serial number for the particular component in question or some other type of information or might more likely be assigned internally by the software and database of the present invention. It is explicitly contemplated that for the sake of maintaining the integrity of a unique component ID index that the component ID 16 would be generated or assigned by the software of the present invention, rather than entered manually by the user through the user interface. The entire creation of these component records 15 could be done in a “back office” data import fashion, where the data file obtained from manufacturers or elsewhere could simply be imported to the database 10 and the necessary records created, or it could also be possible to present to a central user interface a data entry interface by which certain information pertaining to piping components 1 to be tracked in the system of the present invention can be entered by user, and other items including the component ID 16 could be automatically generated and attached.

Following or in addition to the generation or attachment of a component ID 16 with respect to the piping component or components in question, shown at step 11-1, the system of the present invention can capture additional manufacturer data 17 or other attribute data 29 with respect to the component or components for which the component record or records 15 are to be created. This could again be done by way of a data import or by manual data entry in a user console. The manufacturer data 17 or other attribute data 29 which might be captured at the time of population of these records could be anything from most basic information such as mapping the component ID 16 against manufacturer serial numbers, entering manufacturer names, locations or dates, or the like, or entering other more detailed attribute data 29 with respect to the components. The import or data entry of any additional manufacturer data 17 or other attribute data 29 which it was desired to associate with the initially populated component record 15 is shown at step 11-2. In an alternate embodiment not shown, the gathering of the data shown in step 11-2 could actually be done in advance of the assignment of the component ID 16 and the creation of the related data and record structure.

Referring back to FIG. 11, the next step which is shown in the creation of population of the component records 15, at 11-3, is the creation of the component record or records 15 within the attribute database 10. Software components resident on the server of the present invention operatively connected to administer the attribute database 10 would create the necessary entries within the data structure to create a component record 15 corresponding to each piping component 1 from which a record was to be created, and that would include the attachment of a unique component ID 16 to each record 15 and the entry of any captured manufacturer data 17 with respect to the related component 1 which was also desired to be included in the record 15. Shown at 11-4 is the creation of additional inspection attribute records 25. If none of the inspection attribute data 29 which was entered was required to be stored in a separate table structure from the component record 15 itself, step 11-4 would not be required. Following the completion of this first level population method, there would be a component record 15 within the attribute database 10 for the necessary pipeline piping components 1 such that the remainder of the method of the present invention could begin to be implemented.

Following the assignment of the component ID 16 in respect of a specific physical piping component 1, the actual physical piping component 1 would need to be marked or identified with the component ID 16 such that as that component 1 made its way through the remainder of a manufacturing or treatment process or was otherwise handled during manufacture of the pipeline it would be quick and easy to identify the component 1 for the sake of capturing additional inspection attributes or inspection information to the attribute database 10 through the user interface of a client device. In any event, the creation of a component record 15 in the attachment of a component ID 16 from that record to the physical component 1 would be the first two steps towards record-keeping in accordance with the remainder of the system and method of the present invention. Eventually when the component 1 corresponding to a component record 15 is assembled into the pipeline at a particular location, location data 18 corresponding to that component 1 will also be captured, by field worker data entry or otherwise by a client device in the field and stored to the component record 15 in fields 18 for that purpose.

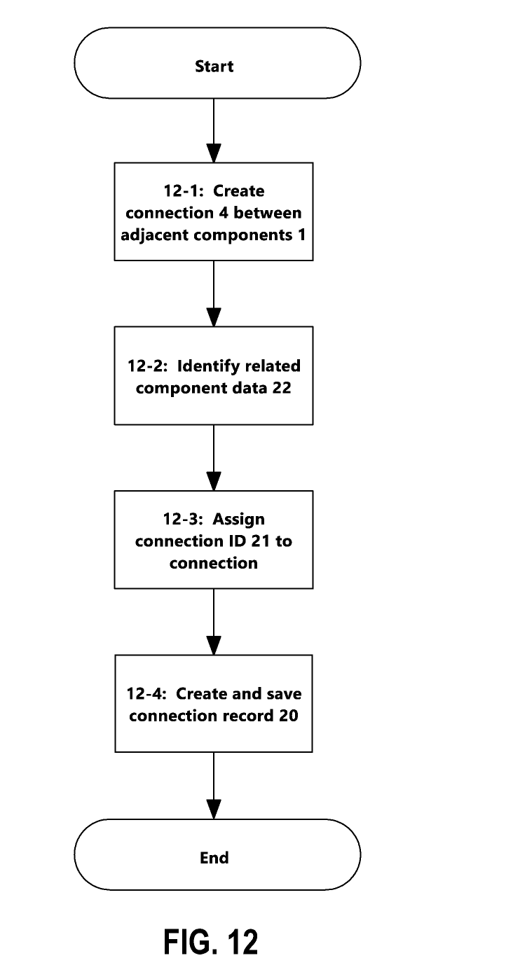

Similar to the creation of component records 15 in the attribute database 10, the method of the present invention also specifically contemplates the creation of connection records 20 in the attribute database 10 corresponding to each connection between adjacent components in the pipeline or section of pipeline being managed in accordance with the system of the present invention. As outlined elsewhere herein, connections 4 between components 1 are the key aspect of the pipeline 6 which it is required to monitor from the perspective of ensuring integrity of the pipeline during construction and in follow-up monitoring and maintenance. FIG. 12 demonstrates the first few steps of the creation or population of connection records 20 within the method of the present invention. One approach which could be taken in terms of the timing of the creation of connection records 20 would be to create these records based upon the plan for construction of a pipeline—that is to say when it is known which type of piping components will be connected, and approximately where, the connection records 20 could be pre-populated within the attribute database 10 so that additional inspection attributes or information could be aggregated or tagged there to as the pipeline planning and construction process proceeded. Pre-population of connection records 20 would also allow for assignment of the conduct a particular connections to particular work teams etc. or may have other workflow or enterprise resource planning advantages associated therewith. Pre-population of connection records 20 within the database 10 would thus be one approach which would have significant workflow benefit in the construction planning phase of the pipeline or piping installation.

An alternative approach to the creation of the pipeline connection records 20 would be to create these records based upon data entry by inspectors in the field using client devices in accordance with the remainder of the software method of the present invention. This is the embodiment which is demonstrated in FIG. 12. Turning to the Figure, step 12-1 shows a physical step in the business method which is the creation of a component connection 4 between two adjacent piping components 1. For example, the welding together of two adjacent pipes into a pipe string, or the attachment of a valve to a pipe etc. would comprise the creation of a component connection 4 between adjacent components 1. Referring back to FIG. 2 for demonstrative purposes, the labels R1, R3, R5, R7, R9, and R11 correspond to connections of piping components in the piping installation.

Once a weld or another type of a component connection 4 is created between two adjacent pipeline piping components 1, that connection 4 is an entity which it is desired to track for inspection and record-keeping purposes in accordance with the remainder of the method of the present invention. From the perspective of creating a component connection record 20 in the database 10, the key pieces of information which would be required from a locational perspective as well as in terms of ordering the components in the pipeline for mapping and visualization purposes in due course are to identify the related components which have been connected. The collection of related component data 22 shown at step 12-2. For example, the identification of two adjacent pipes which are connected in a weld might comprise storing the component ID 16 of each of the two pipes which are connected in the connection in the record. Those component IDs 16 might be the related component data 22 stored in the connection record 20. In certain cases, there may be additional or alternative identifications which could be used to identify the related components—for example a component record 15 might actually include an indication of a particular end of a component or attachment face thereof, so that the related component data 22 stored in the connection record 20 would with even a greater degree of granularity identify the specific faces of which components were connected in a particular connection 4.

Once the related component data 22 are acquired, shown at step 12-2, a component connection ID 21 can be assigned to the connection between those two components. Similar to the component ID 16 which is assigned to each piping component 1 which is the subject of a component record 15, the connection ID 21 which is assigned to each connection between piping components 1 will effectively be the serial number or identifier of that connection used within the attribute database 10 to attach any information with respect to that particular connection 4. Again, referring to FIG. 2, Labels R1, R3, R5, R7, R9, and R11 could comprise connection IDs 21.

The importance and framework for the creation of unique connection identifiers 21 will be understood from a relational database programming perspective by those skilled in the art. The connection identifier 21 will most likely be assigned internally and generated by the software and database of the present invention—it is explicitly contemplated for the sake of maximizing the integrity of a unique connection ID index in the database 10 that the connection ID 21 would be generated or signed by the software rather than entered manually by a user through the user interface. Again, the creation of these connection records 20 could be done in a bulk data import operation on the software on the server, or it could also be done by the presentation to a user data entry interface on a client device. Assignment of the connection ID 21 of a particular connection between two adjacent piping components 1 shown at step 12-3, and the creation and saving of a component connection record 20 which contains the assigned connection ID 21 as well as the related component data 22 is shown at step 12-4. Again, the connection record 20 could and would also in due course include location data and other connection type data 23 which could be used for the sake of storing parameters or inspection results of the connection between the adjacent components 1 as well as for the purpose of physically locating that connection within the overall pipeline installation.

Where the connection record 20 was being created in the field, the client device 41 of the operator creating the record could also be used to capture location coordinates and store the location of the connection 4 in association with the remainder of the connection record 20.

### Authentication and Audit Trail

One of the key aspects which is considered with respect to the present invention, which will further enhance the utility of the system and method of the present invention is a regulatory compliant record-keeping system with respect to various pipeline projects is the ability to authenticate users upon entry of information to the attribute database as well as the capture of an audit trail there with. Authentication and audit logging are two basic concepts of database and software program which will be understood to those skilled in the art and could be implemented in the system and method of the present invention in various ways. All such approaches are contemplated within the scope of the present invention.

Another aspect of a security and authentication model being deployed in the system of the present invention would be the ability to have more than one user validate or sign off the entry of particular attribute data to the attribute database or the creation of records therein. For example, the client which is used to enter various types of attribute data in the field with respect to particular component records could require not only that that information be entered to the client by authenticated user of the system, but when the authenticated user of the system wants to save the information for upload to the attribute database the program might also require that a second authentication take place of another user—for example if a supervisor or second inspector was working in the field along with the first inspector, and it was desired to have two users authenticate or verify various inspection attributes and data, the system could require that two authenticated users, or any number of desired users, be required to effectively authenticate individual data entries of some kinds for the attribute database. Implementation of the multiple user authentication and verification model in the system of the present invention, regardless of its specific infrastructure, is also contemplated within the scope hereof.

The system and method of the present invention will result in the creation of a complete historical inspection log for component connections or components, which can be used for reporting or query purposes.

### Marking Components During Manufacture

It is explicitly contemplated that the components 1 which might be used for construction of a particular piping installation could have their component ID 16 assigned and physically attached to them during or immediately following manufacture. This would allow for the capture of additional inspection attributes or information related to each of those components when inspected at any time during the manufacturing process or the remainder of the construction workflow. For example, by assigning the component ID 16 at that early stage, a component record 15 could be created in the database contemporaneously as well, and attribute information 29 could then start to be captured with respect to the individual components at that early stage and tracked into the database 10 for reporting or other monitoring and record-keeping purposes. Assignment of the component ID 16 early in the process at the time of manufacturing also provides the ability to monitor quantity and availability of piping components during the manufacturing process for the piping installation, since particularly with component ID 16 markings that are RFID tags or other rapidly and easily read technologies, as the piping installation is constructed, the quick reading or capture of those component IDs 16 can result in their deduction from available inventory. This allows for inventory management of available components 1 during the manufacture of a particular piping installation—for example a particular number of strings of pipe might be known to be required, and while within reason they do not need to be used within a particular order, they could be individually subtracted from available inventory on the system and database of the present invention by tracking and attribute in the inspection attribute portion of the database indicating their user connection into the pipeline. Alternatively, another way that they can be automatically removed from available construction inventory would simply be to incorporate a monitoring routine into the database engine that would effectively automatically deduct components from available inventory when they were connected. Creation of a program within the system of the present invention which would maintain a construction inventory of available components 1 based on the available component records 15 in the database, and automatically adjust the available construction inventory of particular types of piping components based upon the use or connection of those specific individual components into the finished piping installation is contemplated within the scope of the present invention.

### Construction Management Process and Component Tracking

There are a number of different construction management processes and methods which could be developed for use in the construction of various piping installations in accordance with the overall method of the present invention. The reasonably contemporaneous field capture of inspection attributes of piping components and connections of the piping installation to an attribute database 10 provides significantly enhanced record-keeping, searching and reporting capabilities over the prior art manual record-keeping methods.

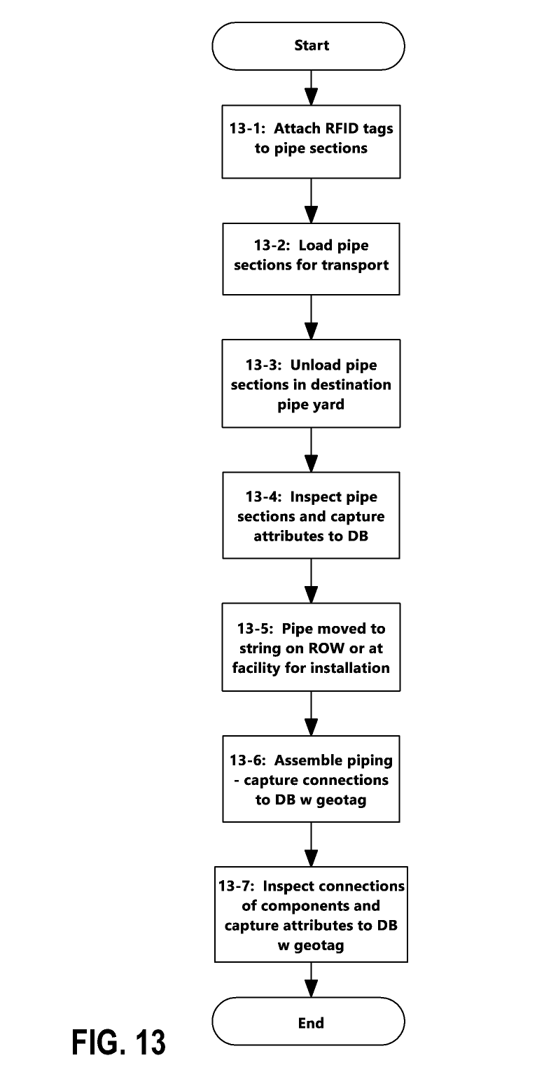

A front to back piping construction method could be deployed in accordance with the present invention, as one such process incorporating the method hereof. FIG. 13 is a flow chart demonstrating one overall piping construction method in accordance with the present invention. As is shown in this method, at step 13-1, component IDs 16 are physically attached to components 1 at the time of manufacture. In this case those are RFID tags being attached to piping sections at the pipe mill. Insofar as the component IDs 16 of being attached to components 1 at that time there would also be at least partially populated component records 15 within the database 10 in accordance with the present invention such that there would be a component record 15 corresponding to each component ID 16 and inspection attributes of the individual component 1 attached to that ID 16 could be captured for storage to the database 10 even during the remainder of the manufacturing, treatment or transport process. For example, if following manufacture the pipe was being coated in another location or some other treatment undertaken, details or inspections of those treatments could be documented to the database in accordance with the method herein, by an operator using a client device 41.

Following the attachment of the RFID tags or component IDs 16 to the components 1, the pipe section components 1 would be loaded for transport at the pipe mill. This is shown at step 13-2. Following the loading of the pipe 1 at the yard, it can be transported to a destination pipe yard.

Upon arrival at its destination, the pipe sections 1 would be unloaded in a destination pipe yard, shown at step 13-3. At that point the individual pipe sections 1 could be further inspected and the results of those inspections, visual or otherwise, could be captured as inspection attributes to the database 10 in respect of the component IDs 16 attached to each pipe section 1. All throughout manufacturing and downstream inspection leading up to the point of construction of the particular piping component 1 into a piping installation, inspection attributes of inspection or other characteristics for each such component 1 could be captured and stored to the database 10 in inspection attribute records therein, subject only to the proper record structure existing in the database 10 to do so.

Shown next at step 13-5 in this Figure, pipes 1 could be moved into position as a pipe string along the right-of-way, or into position at a commercial facility for industrial installation in a non-pipeline application. The piping installation would be constructed, shown at step 13-6, and in accordance with the method of the present invention and operator using the client device would capture the details of the connections of adjacent components 1 by completing connection records 20 with respect to each connection between a pair of adjacent components 1. Those connections 4 would be captured in these connection records 20 to the database 10, likely along with the geo-tag or geo-referenced in terms of a location in respect of each connection.

Finally, shown at step 13-7, the connections of piping components could be inspected further and any inspection results or other inspection attributes of the connections, or of the components themselves anytime, could be stored to the database 10 in correspondence with a component connection record 20 or a component record 15 in accordance with the remainder of the data capture and storage system and method herein.

As outlined elsewhere above, it is specifically contemplates client devices 41 which could be used in accordance with the method the present invention could either have a live wireless connection to the network so that it had direct and dynamic access to the database 10 for the purpose of retrieving and saving information thereto, or in other applications the client software on the client device 41 may store a local dataset or subset of the database 10 with respect to the components 1 or component connections 4 in respect of which it is thought that the particular operator of that client device 41 will need information, and the client device 41 to be periodically synchronized with the server 44 and the attribute database 10 for the sake of uploading updates to or new records in respect of the database 10. Each time that an update is provided to the attribute database, up-to-date reporting can be generated with respect to the entire installation project, since all of the information contained within the database 10 will be up-to-date with all of the data captured in the field, and no transcription or transposition of manual record-keeping is required.

It will be understood that this Figure demonstrates only one embodiment of an end-to-end pipeline assembly and construction method in accordance with the remainder of the method of the present invention. Many different processes that are similar in nature but might order the steps in the process somewhat differently, but similarly rely upon the underlying data collection and manipulation methodology of the present invention will be understood to be contemplated within the scope hereof.

### Updating Available Component Construction Inventory

As outlined, use of the database and method of the present invention during construction of the piping installation would provide for an ability to automatically update an available piping installation component inventory. The inventory would first be created by creating the necessary component records 15 within the database 10 for each available component 1 as it became available for use. Either details or summary inventory reports could be created to run against the database 10 which would either list or count available components of certain types. Added flexibility or detail could be created in these reports or in this aspect of the invention, such that either an available printed report or even an available dashboard on a client device could show available quantities are specific available components to the construction crews for selection and use in piping installation construction.

Creation of the component records 15 could be used as a method by which to count available pipeline construction components. The available construction inventory of piping components could be updated to remove any no longer available components i.e. components that either have been rejected or components that have been added already into the piping installation. The primary means of removing from available construction inventory components 1 that had been used in construction would be to use queries or update the necessary reporting records and flags in the database 10 to be removed from the list of available construction components any components 1 which had been connected in a component connection 4. As such, a component which has a record 15 could be considered an available construction component, whereas a component which appears as a related component to a component connection record 20 could be taken out of available inventory on the basis that it has been connected and used. As is the case with many of the other business processes which could be facilitated in accordance with the overarching method of the present invention will be understood that many different modifications or improvements could be made to this basic concept of providing and updating available component construction inventory and all such modifications or improvements are contemplated within the scope of the present invention.

### Marking of Welds or Component Connections

As outlined elsewhere herein it is explicitly contemplated that upon the completion of each weld or connection 4 in the assembly of the piping installation, that connection 4 would be physically assigned a component connection identifier 21. The physical assignment of the connection identifier 21, which may have been previously assigned to that connection in pre-population of connection records 20 in the database 10 or might otherwise be assigned at the time of completion, comprises the completion or creation of a component connection record 20 in the database along with the physical attachment or marking of the assigned connection identifier 21 onto or near the connection itself. By assigning an identifier to the connection onto or near the connection itself and storing that in the database 10 along with a geo-referenced location, it is possible to quickly and efficiently locate a particular discrete connection 4 for subsequent inspection or maintenance. As is the case with the components 1, the majority of the connections 4 in a commercial or industrial piping installation may already have some type of a serial identifier attached thereto and it may simply be the case that the same identifier was used for this purpose as well. Various workflows could be developed around the physical marking of component connections 4—any workflow which involves the attachment at or in proximity to the connection 4 of a physical embodiment of its connection identifier 21 along with or in parallel to the creation of a corresponding connection record 20 in the database 10 is contemplated herein.

As outlined, there may be other situations or embodiments of the invention in which the connections 4 were not identified as freestanding entities from attracting prospective and rather the details and inspection attributes of individual connections were stored in relation to the component records 15 of the two components that were connected in a particular connection. It is contemplated that the most desirable embodiments of the invention will involve separately identifying and tracking each connection 4.

### Capturing Manufacturing Inspection Attributes of Piping Components

By assigning and physically attaching component IDs 16 to piping components 1 early in the manufacturing process, manufacturing or other inspection attributes of those components 1 which are captured, observed or measured even within the confines of the manufacturing or transport process could be captured quickly for storage to the database 10 by using a similar approach with the client device 41 in association with the remainder of the system the present invention. The client device 41 again could capture the component ID 16 of one or more components 1 and allow for the tagging of one or more inspection attributes 29 in respect of those components 1 to the database 10 in accordance with the remainder of the inspection attribute capture and tracking method of the present invention. This would allow for upstream inspection or manufacturing processes to all be tracked in the database 10.

Batches of piping components 1 could also be tracked from a transportation perspective in accordance with the present invention if the component IDs 16 were attached to them early in the process. For example, if RFID tags were placed on each component 1 to provide the ability to acquire the component ID 16 from a particular one of those components 1, passing an entire transport batch or load of those components 1 under or alongside an RFID reader could capture all of the RFID signatures applied to all of those components 1 and for the purpose of tracking locations, transport or other batch level inspection attributes this could be considered beneficial.

### Field Inspection Following Construction

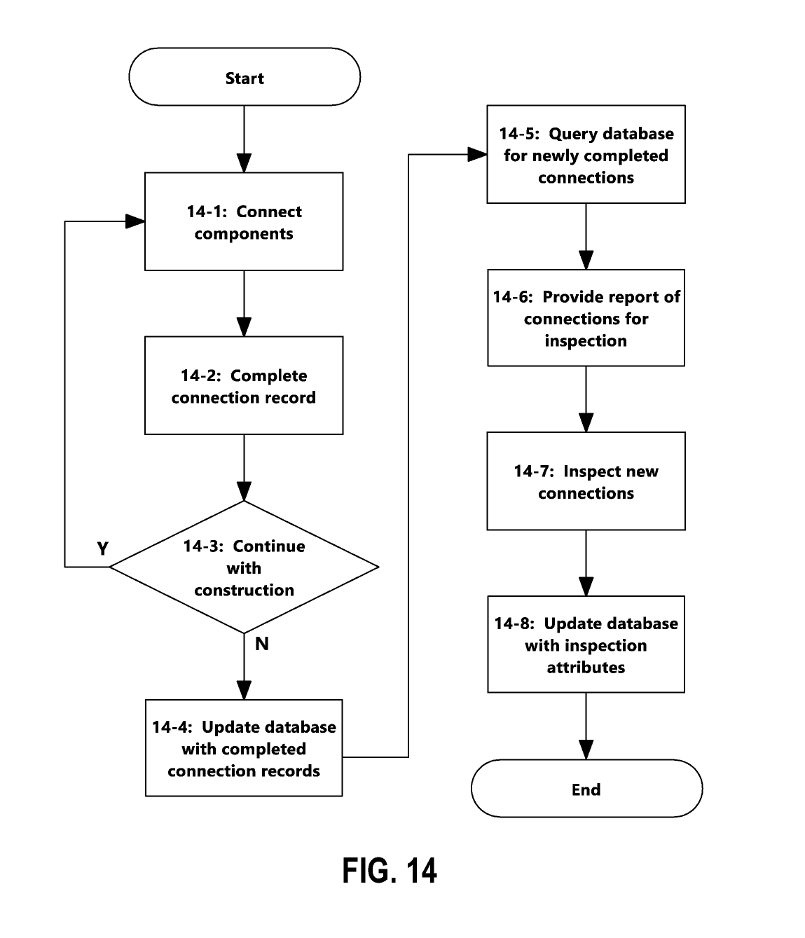

One of the key business methods which will be enabled by the data capture and manipulation method of the present invention, and one of the key commercial benefits of the system of the present invention, will be the enhanced method of following inspection of construction within the context of the assembly of piping installations in accordance with the remainder of the present invention. One of the commercial problems in the past with FIG. 14 the construction of piping installations has been that where manual data is captured it either is entered or concatenated or aggregated very late in the process such that follow-up inspection is delayed, or in some cases aggregation of the manual inspection records which are created from the connection of piping components etc. maybe missed altogether. It is desirable for the follow-on inspection team in a piping construction project to have as contemporaneous as possible of data indicating which connections or welds between components 1 had been completed, so that they can be inspected before the piping installation is either put into service, or in the case even of underground piping before the piping is buried. Otherwise sometimes it will come to pass when the manual records are eventually reviewed that it will be found that certain welds or component connections 4 between certain components 1 may never have been completely or properly inspected. Obviously minimizing this and maximizing the consistency and efficiency of inspection and completion of pipeline and other piping construction projects would be a significant commercial benefit.

FIG. 14 is a flowchart showing one embodiment of the steps of the business method, relying on the system and method of the present invention part, to properly inspect in a timely fashion the completion of component connections 4 in the assembly of the piping installation. There is shown at step 14-1 the manufacture of a particular connection 4 in the context of a piping installation construction project. Following the completion of that connection 4, the welding team would complete the connection record 20 in the database 10, using a field client device 41. This is shown at step 14-2. As soon as the client device 41 updates the attribute database 10 or synchronizes with the central system in a case where it was not always online in real time, a query against the database 10 could not only provide up-to-date information regarding the construction component inventory insofar as the system would then know that certain components had been connected into the piping installation were no longer available, but the actual connection records themselves 20 which had been completed or partially populated at the least by the welding team or other manufacturing team could be identified in the database query as well. Identification of completed connection records would indicate a completed connection, and the completed connections would be the connections which required additional inspection and verification before signoff on the completion of the project.

Shown at step 14-3 is a loop in the construction in this Figure. The construction team may continue with the connection of additional components and repeat steps 14-1 and 14-2. Following the conclusion of a particular working session, when the no decision leg of step 14-3 is selected, the client device 41 of that particular construction team could be synchronized up to the database 10. This is shown at step 14-4. Again, in this particular embodiment, for demonstrative purposes, what is contemplated here is the fact that the client device 41 is not actively connected in real time over the network to the server 44—as it could be in some embodiments of the system and method. In others as outlined, and is demonstrated with this particular business flow step, the client device 41 would be periodically synchronized with the attribute database 10, wirelessly or otherwise, by a momentary network connection to the server 44. Both such approaches are contemplated within the scope of all of the variations on the business methods outlined herein.

Following the update of the attribute database 10 with the details of completed connection records 20 from the client device 41 of one or more construction teams, periodic queries executed against the database 10 for newly completed connections 4, shown at step 14-5, could identify new connections 4 which required secondary or follow-up inspection etc. Any manner of inspection or follow-up audit workflows could be built around this and accommodated within the remainder of the system and method herein. Following the execution of the query against the database for newly completed connections shown at step 14-5, a report could be executed or provided to an inspection team or other personnel for the purposes of identifying connections requiring inspection. This is shown at step 14-6. That report would in all likelihood also include the physical or geo-locations of the connections 4 requiring inspection, since the geolocation of each connection 4 would be stored in the connection record 20 associated there with.

Carrying on in the business method shown in FIG. 14, inspectors would inspect these new connections 4—this is shown at step 14-7. The database 10 would be updated from the client device 41 of the inspectors, shown at step 14-8, and so long as the particular connection 4 past its inspection as adjudicated either by the inspectors are the system, the inspection attributes having been updated to the database 10, the method would be at close.

There are also any manner of pipeline maintenance methods which could be developed based on monitoring the inspection attributes stored within the database 10 with respect to various components 1 or component connections 4. Querying or reporting for components or component connections requiring maintenance or other inspection could include listings of the locations as well of those components or component connections since again the corresponding records 15, 20 within the database would include the location information.

### Capturing Locationally Referenced Pipeline Asset Inventory

Another aspect of the present invention is the ability to use the system and method herein to in a streamlined and automated fashion capture or verify an inventory of pipeline assets in a finished pipeline construction project. This might be done to create a final map or listing of all of the components present in a completed pipeline.

By traveling along a completed pipeline tracked in accordance with the remainder of the method of the present invention, and sequentially or serially capturing the component ID 16 or connection ID 21 of each piping component 1 or connection 4 encountered, there is a means of capturing additional location relevance information for capture to the attribute database. For example, by traveling along the pipeline and capturing in sequential order the identifiers 16, 21, a listing of piping components or component connections in the finished pipeline can be assembled and actually used to also construct a visual map of the pipeline or piping installation in question. Particularly in the case of RFID marking being done on the components and/or component connections, this type of a visible pipeline or piping installation map could be captured by simply walking are traveling along the pipeline or installation and automatically capturing the identifiers 16, 21 without the need even for human intervention. Each time that an identifier 16 or 21 was captured in this type of a method, that identifier 16, 21 could also be tied to the GPS location at which it was captured or whatever other type of a GIS locational technology was being used and stored along with the identifier as an attribute or elsewhere in the attribute database. The method of assembling a set of mapping information with respect to individual components in a pipeline or piping installation, comprising marking each component or connection thereof such that it can be noninvasively tracked, or the identification thereof captured upon an inspection of the pipeline or piping installation, and tying the capture of each identifier to a physical or geographic location by GPS or otherwise, is contemplated within the scope hereof. This would allow, with the data captured, for the rapid assembly of the necessary information to understand the order of piping components within the assembled pipeline, along with their GIS location for rapid geographic location of a component requiring inspection or repair. It is specifically contemplated that this type of a method work very well with RFID marking being used as the marking technology for components or component connections, since RFID markings could be captured or read by simply traveling along the pipeline or piping installation without the need for manual data capture at all.

This type of a data capture or pipeline inspection routine might also be used without the capture of GIS coordinates with respect to the detection of each component or connection identifier 16, 21. Either approach will be understood to those skilled in the art. Generally speaking, these types of systems can be governed with a “the more data the better” approach and so GIS coordinates would likely be captured with respect to each identifier 16, 21, but in certain circumstances it may simply be desired to construct or capture the serial identifier data with respect to components in an installation without geo references.

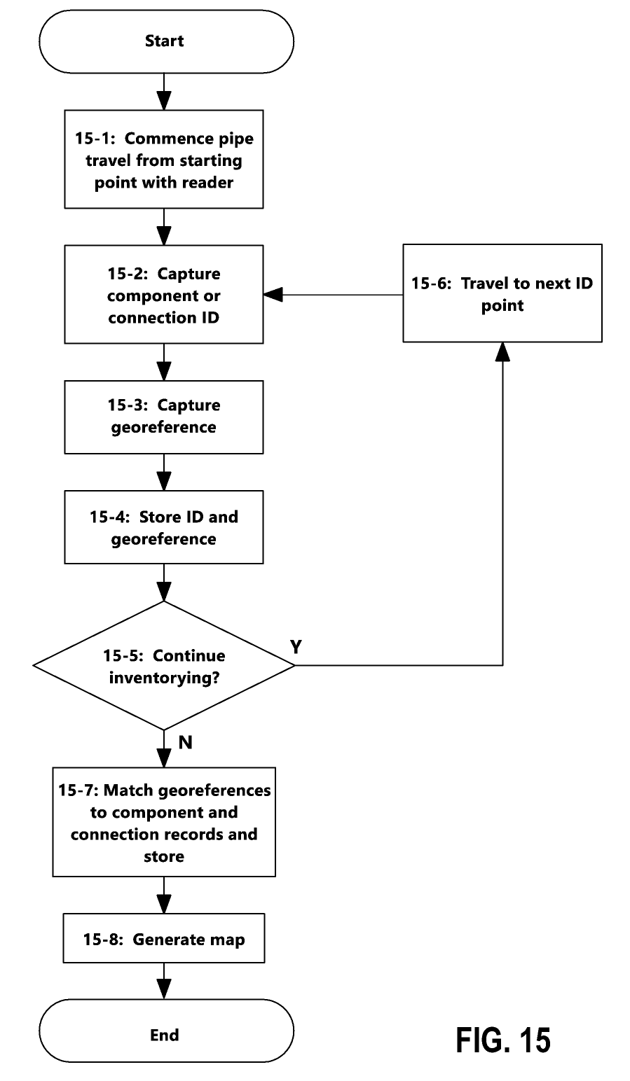

FIG. 15 shows a flowchart of one embodiment of the method of the present invention for the capture of a locationally referenced pipeline asset inventory in accordance with the present invention. Again, the variations which are possible on this particular approach or method will be many without departing from the expressed scope and desired intention hereof. It is contemplated that in accordance with the overall method of the present invention, where the piping installation is appropriately marked along its length with the necessary component IDs 16 and connection IDs 21, personnel with appropriate reading equipment can travel on the length of the piping installation and capture a geo-referenced inventory of pipeline assets or components.

The reader which would in all likelihood be used to be a client device 41 in accordance with the remainder of the present invention which included any necessary equipment for the reading of the physical identifications of the component IDs 16 or the connection IDs 21 upon the pipeline—for example if the markings of the identifiers were physically in place on the piping installation using RFID tags, a client device 41 which incorporated or was connected to an RFID reader which could in cooperation with the remainder of the client software 57 on the device etc. read those RFID tags for the purpose of capturing the identifiers or other information as may be required by this method there on would be used.

Looking at step 15-1, the user with the appropriate client device 41 would commence traveling along the piping installation from a starting point with the client device 41. Shown at 15-2 is the encounter and capture of the component ID 16 or connection ID 21 by the client device 41. This might either be done in an automatic scanning fashion, or in other embodiments, the personnel might simply goal and locate the physical embodiments of those identifiers and enter them into the system or capture them automatically if they were readable tag, barcode or the like.

When an identifier 16, 21 was captured by the client device 41, the device 41 would also capture a geo-reference at that time. Capturing a geo-referenced such as a GPS fix or the like is shown at step 15-3. The particular component of connection identifier along with the geo-reference is stored on the device 41, shown at step 15-4.

Personnel can then continue to move along the piping installation, continuing to inventory additional components or component connections. If it was decided to continue inventorying, the decision block being shown at step 15-5, the personnel with the reading client device 41 would travel to the next identification point along the piping installation, shown at step 15-6. This would simply be the next point along the piping installation of which there was endorsed a component ID 16 or connection ID 21 on a component 1 or a component connection 4. At that point the method within loop again through the capture of the ID and the related geo-reference and storage thereof on the device 41.

Following the completion of the particular inventorying session, shown in the direction of the no decision leg at step 15-5, the client device could transmit the captured identifiers NGO references, in pairs or whatever other type of data transmission was designed, to the server 44 for storage to the database 10. This is shown at step 15-7. In the case of this Figure this is again shown in a static form where the communication of the pairs of identifiers and geo-references were being communicated in a batch form from time to time. It will also be understood that in the case that the client device 41 having a live network connection to the server 44 at all times, these pairs of data points could be transmitted for storage or handling every time they were captured rather than holding them in memory for batch transmission. Both such approaches are contemplated herein.

In any event by moving along the piping installation and sequentially or serially capturing the identifiers and geo-references or locations of each identifier in accordance with GPS or whatever other location technology was used, the system and method would assemble a sequential listing of all the components and connections. The sequential listing, with location coordinates thereon, could be useful for any number of different purposes. For example, shown at step 15-8 is the optional step of generating a map or other kind of a blueprint or graphic—based upon the capture of the component ID 16 or the connection ID 21, each of those would correspond to a record 15, 20 in the database 10 and so by capturing in sequential order the locations of each component or connection, that information could be either verified or captured en masse for upload to the database 10 to match up with the remainder of all of the record data stored with respect to each component or connection in the system. The generation of a map shown at step 15-8 is an optional step—mapping components, or a mapping software which could work in conjunction with a query from the database 10 including location coordinates, could be incorporated into the software of the remainder of the present invention on the server and the administrative user interface—or for that matter the client device 41 user interface—and all such modifications or enhancements to the underlying method of the present invention again are contemplated within the scope of the present invention.

While specific embodiments of the present invention have been described, it will be apparent to those skilled in the art that various modifications thereto can be made without departing from the spirit and scope of the invention. Accordingly, the foregoing description of the preferred embodiments of the invention and the best mode for practicing the invention are provided for the purpose of illustration only and not for the purpose of limitation.

What is claimed is:

1. A method of tracking inspection attributes of component connections in a piping installation, each component connection representing a component connection of at least one connection point of at least two adjacent piping components, said method comprising:
providing a server comprising:
a network interface for communication with at least one field inspection client device;
an attribute database comprising:
a plurality of connection records each identifying a component connection and a physical location of the component connection within the completed piping installation;
a plurality of inspection attribute records each linked to a component connection record, each inspection attribute record storing at least one inspection attribute of the related identified component connection; and
tracking software for administering the attribute database, managing communications with the field inspection client devices and conducting the remainder of the method;
serially marking the component connections in the piping installation;
upon completion of a nondestructive inspection of a component connection, allowing an operator using an operator interface of a field inspection client device and an inspection data entry interface served from the server to the field inspection client device, to enter the serial marking of the component connection and at least one inspection attribute value to be stored in respect of the inspection and the component connection and transmit same to the server in a component connection inspection transmission;
on receipt of a component connection inspection transmission by the server, using the tracking software:
identifying a component connection record in the attribute database corresponding to the connection inspected; and
creating an inspection attribute record in respect of the component connection in the attributes database storing the inspection attribute values received and a timestamp for creation of the record;
wherein as inspection attribute records are added to the attributes database a complete chronological inspection history of the component connection is created for subsequent query and reporting purposes.

2. The method of claim 1 wherein at least one component connection record also stores at least one inspection parameter and generating a user notification when an inspection attribute record is stored to the database indicating an inspection attribute value outside of said acceptable inspection parameters.

3. The method of claim 1 wherein the field inspection client device is locationally aware and can present the details of proximate piping components and component connections to the operator for use in the data entry of inspection attribute values, based upon comparison of the location of the field inspection client device with the locations of piping components or component connections stored within the database.

4. The method of claim 1 wherein a component connection is a weld, and at least one inspection attribute stored to the database with respect to the weld are results from inspection of the weld.

5. The method of claim 1 wherein a component connection comprises a connecting component installed between adjacent piping components.

6. A server for use in tracking inspection attributes of serially-marked component connections in a piping installation, each component connection representing a component connection of at least one connection point of at least two adjacent piping components, said server comprising:
a network interface for communication with at least one field inspection client device;
an attribute database comprising:
a plurality of connection records each identifying a component connection and a physical location of the component connection within the completed piping installation; and
a plurality of inspection attribute records each linked to a component connection record, each inspection attribute record storing at least one inspection attribute of the related identified component and a timestamp of the creation time of the record;
tracking software for administering the attribute database and managing communications with field inspection client devices via the network interface;
wherein the server can receive via the network interface from a client device a component connection inspection transmission comprising at least one inspection attribute related to an identified component connection, being an entered connection inspection attribute;
and wherein on receipt of a component connection inspection transmission at the server, the tracking software will create an inspection attribute record in the attribute database storing the details of the entered inspection attributes in relation to the identified component connection along with a timestamp of creation of the record;
and wherein as inspection attribute records are added to the attributes database a complete chronological inspection history of the component connection is created for subsequent query and reporting purposes.

7. The server of claim 6 wherein at least one component connection record also stores at least one inspection parameter, and the tracking software can generate a user notification when an inspection attribute record is stored to the database indicating an inspection attribute outside of said acceptable inspection parameters.

8. The server of claim 6 wherein at least one field inspection client device is locationally aware and can present the details of proximate piping components and component connections to the operator for use in the data entry of inspection attribute values, based upon comparison of the location of the field inspection client device with the locations of piping components or component connections stored within the database.
